(19) United States
(12) Patent Application Publication
(10) Pub. No.: US 2026/0359401 A1
(43) Pub. Date: Nov. 12, 2026

(54) DEVICE PAIRING

(71) Applicant: Apple, Inc., Cupertino, CA (US)

(72) Inventors: Matthias LERCH, San Francisco, CA (US); Frank R. BAYERBACH, San Jose, CA (US); Li LI, Saratoga, CA (US); Sven J. HOFMANN, Munich (DE); Yogesh D. KARANDIKAR, San Jose, CA (US)

(21) Appl. No.: 19/552,908

(22) Filed: Feb. 27, 2026

Related U.S. Application Data
(60) Provisional application No. 63/804,493, filed on May 12, 2025.
(60) Provisional application No. 63/887,261, filed on Sep. 24, 2025.

(51) Int. Cl. G06F 21/12; G06F 21/64; G06F 21/73

(52) U.S. Cl. CPC G06F 21/123; G06F 21/64; G06F 21/73

(57) ABSTRACT

The present disclosure generally relates to pairing with a device. Some techniques are for obtaining a pairing code in accordance with some embodiments. Other techniques are for establishing different types of ownership in accordance with some embodiments.

### CROSS-REFERENCE TO RELATED APPLICATIONS

This application claims priority to U.S. Provisional Patent Application Ser. No. 63/887,261, entitled “DEVICE PAIRING,” filed Sep. 24, 2025, and to U.S. Provisional Patent Application Ser. No. 63/804,493, entitled “DEVICE PAIRING” filed May 12, 2025. The content of these applications is hereby incorporated by reference in their entirety.

### BACKGROUND

Electronic devices are becoming increasingly interconnected. For example, personal devices (e.g., mobile phones and/or tablets) are often paired to other electronic devices. Pairing such electronic devices has become more difficult as the configurations of those connections have become more complicated. Accordingly, there is a need to improve techniques for pairing devices.

### SUMMARY

Current techniques for pairing with a device are generally ineffective and/or inefficient. For example, some techniques require users to open an application of an electronic device and set up a connection with a different electronic device through communications between the application and the different electronic device. This disclosure provides more effective and/or efficient techniques for pairing devices using an example of a smartphone pairing with a vehicle. It should be recognized that other types of devices can be used with techniques described herein. For example, a smartphone can pair with a laptop using techniques described herein. In addition, techniques optionally complement or replace other techniques for pairing with a device.

Some techniques are described herein for initiating a pairing process using a pairing code that is received from a server. Other techniques described herein for receiving data with a pairing code or receiving data without a pairing code.

In some embodiments, a method that is performed at a device is described. In some embodiments, the method comprises: receiving, from a hardware component, a credential in conjunction with the device detecting the hardware component; in response to receiving the credential, sending, to a server separate from the device, the credential; after sending the credential, receiving, from the server, a pairing code corresponding to another device, wherein the other device is separate from the device and the server; and after receiving the pairing code, initiating, with the other device, a pairing process using the pairing code.

In some embodiments, a non-transitory computer-readable storage medium storing one or more programs configured to be executed by one or more processors of a device is described. In some embodiments, the one or more programs includes instructions for: receiving, from a hardware component, a credential in conjunction with the device detecting the hardware component; in response to receiving the credential, sending, to a server separate from the device, the credential; after sending the credential, receiving, from the server, a pairing code corresponding to another device, wherein the other device is separate from the device and the server; and after receiving the pairing code, initiating, with the other device, a pairing process using the pairing code.

In some embodiments, a transitory computer-readable storage medium storing one or more programs configured to be executed by one or more processors of a device is described. In some embodiments, the one or more programs includes instructions for: receiving, from a hardware component, a credential in conjunction with the device detecting the hardware component; in response to receiving the credential, sending, to a server separate from the device, the credential; after sending the credential, receiving, from the server, a pairing code corresponding to another device, wherein the other device is separate from the device and the server; and after receiving the pairing code, initiating, with the other device, a pairing process using the pairing code.

In some embodiments, a device is described. In some embodiments, the device comprises one or more processors and memory storing one or more programs configured to be executed by the one or more processors. In some embodiments, the one or more programs includes instructions for: receiving, from a hardware component, a credential in conjunction with the device detecting the hardware component; in response to receiving the credential, sending, to a server separate from the device, the credential; after sending the credential, receiving, from the server, a pairing code corresponding to another device, wherein the other device is separate from the device and the server; and after receiving the pairing code, initiating, with the other device, a pairing process using the pairing code.

In some embodiments, a device is described. In some embodiments, the device comprises means for performing each of the following steps: receiving, from a hardware component, a credential in conjunction with the device detecting the hardware component; in response to receiving the credential, sending, to a server separate from the device, the credential; after sending the credential, receiving, from the server, a pairing code corresponding to another device, wherein the other device is separate from the device and the server; and after receiving the pairing code, initiating, with the other device, a pairing process using the pairing code.

In some embodiments, a computer program product is described. In some embodiments, the computer program product comprises one or more programs configured to be executed by one or more processors of a device. In some embodiments, the one or more programs include instructions for: receiving, from a hardware component, a credential in conjunction with the device detecting the hardware component; in response to receiving the credential, sending, to a server separate from the device, the credential; after sending the credential, receiving, from the server, a pairing code corresponding to another device, wherein the other device is separate from the device and the server; and after receiving the pairing code, initiating, with the other device, a pairing process using the pairing code.

In some embodiments, a method that is performed at a first device is described. In some embodiments, the method comprises: after obtaining, from a hardware component, a credential, sending, to a server separate from the first device, the credential; and after sending the credential to the server: in accordance with a determination that the server has not shared an owner key for a second device, receiving, from the server, data without a pairing code; and in accordance with a determination that the server has shared an owner key for the second device, receiving, from the server, data with a first pairing code, wherein the first pairing code corresponds to the second device.

In some embodiments, a non-transitory computer-readable storage medium storing one or more programs configured to be executed by one or more processors of a first device is described. In some embodiments, the one or more programs includes instructions for: after obtaining, from a hardware component, a credential, sending, to a server separate from the first device, the credential; and after sending the credential to the server: in accordance with a determination that the server has not shared an owner key for a second device, receiving, from the server, data without a pairing code; and in accordance with a determination that the server has shared an owner key for the second device, receiving, from the server, data with a first pairing code, wherein the first pairing code corresponds to the second device.

In some embodiments, a transitory computer-readable storage medium storing one or more programs configured to be executed by one or more processors of a first device is described. In some embodiments, the one or more programs includes instructions for: after obtaining, from a hardware component, a credential, sending, to a server separate from the first device, the credential; and after sending the credential to the server: in accordance with a determination that the server has not shared an owner key for a second device, receiving, from the server, data without a pairing code; and in accordance with a determination that the server has shared an owner key for the second device, receiving, from the server, data with a first pairing code, wherein the first pairing code corresponds to the second device.

In some embodiments, a first device is described. In some embodiments, the first device comprises one or more processors and memory storing one or more programs configured to be executed by the one or more processors. In some embodiments, the one or more programs includes instructions for: after obtaining, from a hardware component, a credential, sending, to a server separate from the first device, the credential; and after sending the credential to the server: in accordance with a determination that the server has not shared an owner key for a second device, receiving, from the server, data without a pairing code; and in accordance with a determination that the server has shared an owner key for the second device, receiving, from the server, data with a first pairing code, wherein the first pairing code corresponds to the second device.

In some embodiments, a first device is described. In some embodiments, the first device comprises means for performing each of the following steps: after obtaining, from a hardware component, a credential, sending, to a server separate from the first device, the credential; and after sending the credential to the server: in accordance with a determination that the server has not shared an owner key for a second device, receiving, from the server, data without a pairing code; and in accordance with a determination that the server has shared an owner key for the second device, receiving, from the server, data with a first pairing code, wherein the first pairing code corresponds to the second device.

In some embodiments, a computer program product is described. In some embodiments, the computer program product comprises one or more programs configured to be executed by one or more processors of a first device. In some embodiments, the one or more programs include instructions for: after obtaining, from a hardware component, a credential, sending, to a server separate from the first device, the credential; and after sending the credential to the server: in accordance with a determination that the server has not shared an owner key for a second device, receiving, from the server, data without a pairing code; and in accordance with a determination that the server has shared an owner key for the second device, receiving, from the server, data with a first pairing code, wherein the first pairing code corresponds to the second device.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 1H is a block diagram illustrating a device for pairing with a device in accordance with some embodiments.

FIG. 2 is a block diagram illustrating a device with interconnected subsystems in accordance with some embodiments.

FIG. 3 is a flow diagram illustrating a process of pairing an owner device to a vehicle in accordance with some embodiments.

FIG. 4 is a swim lane diagram illustrating a process of pairing a device to a vehicle in accordance with some embodiments.

FIG. 5 is a flow diagram illustrating a process of sharing a digital credential between an authorized entity and a device in accordance with some embodiments.

FIG. 6 is a flow diagram illustrating a process for obtaining a pairing code in accordance with some embodiments.

FIG. 7 is a flow diagram illustrating a process for establishing different types of ownership in accordance with some embodiments.

FIG. 8 is a flow diagram illustrating a process for pairing with a vehicle in accordance with some embodiments.

FIG. 9 is a flow diagram illustrating another process for pairing with a vehicle in accordance with some embodiments.

FIG. 10 illustrates exemplary user interfaces for initiating a process to obtain a digital key in accordance with some embodiments.

FIG. 11 illustrates exemplary user interfaces for continuing a process to obtain a digital key in accordance with some embodiments.

FIG. 12 illustrates exemplary user interfaces for a process to pair with a vehicle in accordance with some embodiments.

FIG. 13 illustrates exemplary user interfaces for another process to pair with a vehicle in accordance with some embodiments.

FIG. 14 illustrates exemplary user interfaces for yet another process to pair with a vehicle in accordance with some embodiments.

FIG. 15 is a flow diagram illustrating a process for pairing with a vehicle in accordance with some embodiments.

FIG. 16 is a swim-lane illustrating another process for pairing with a vehicle in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms unless explicitly stated with an order and/or that they are separate and/or different. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

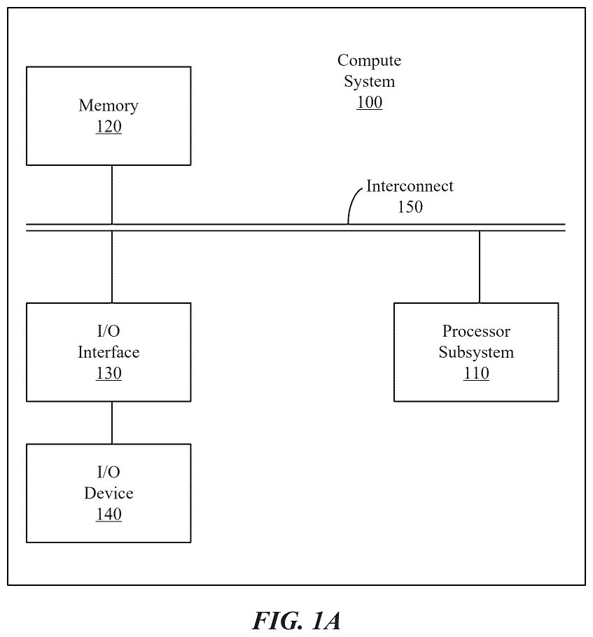

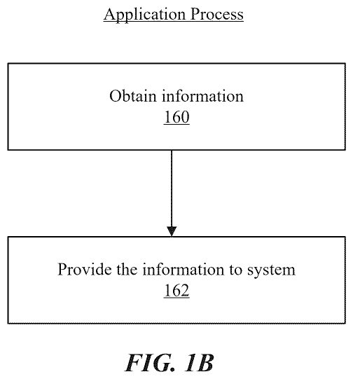

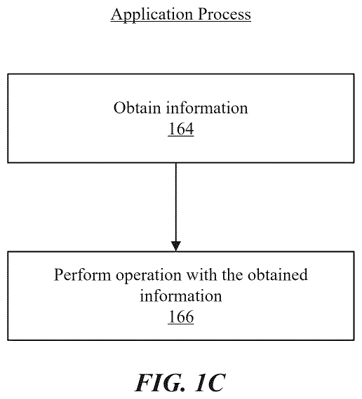

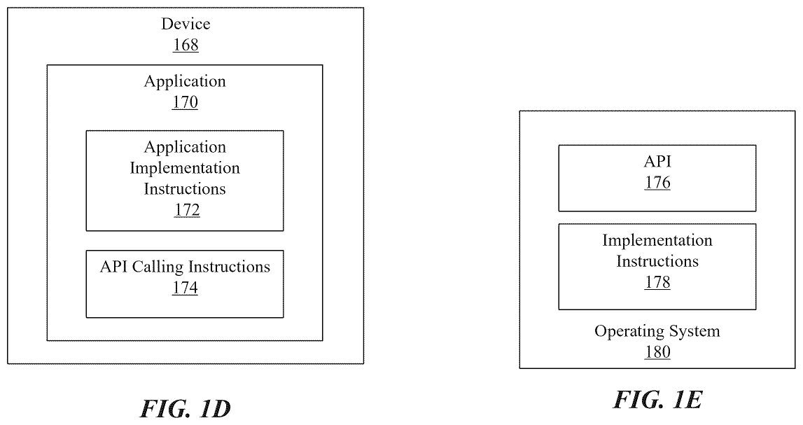

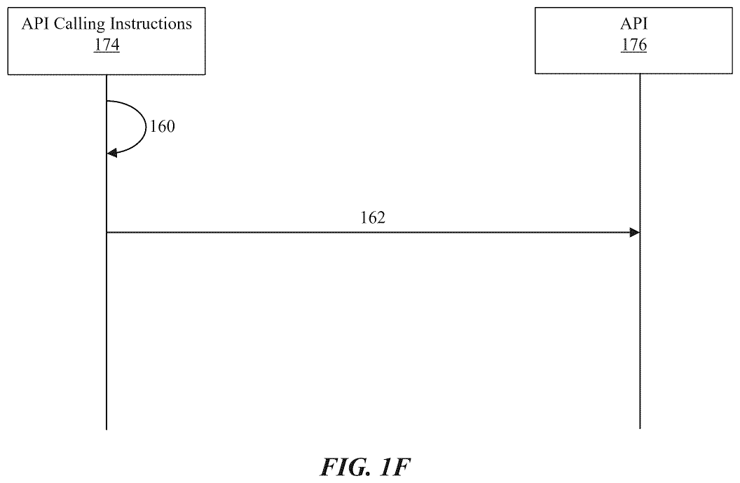

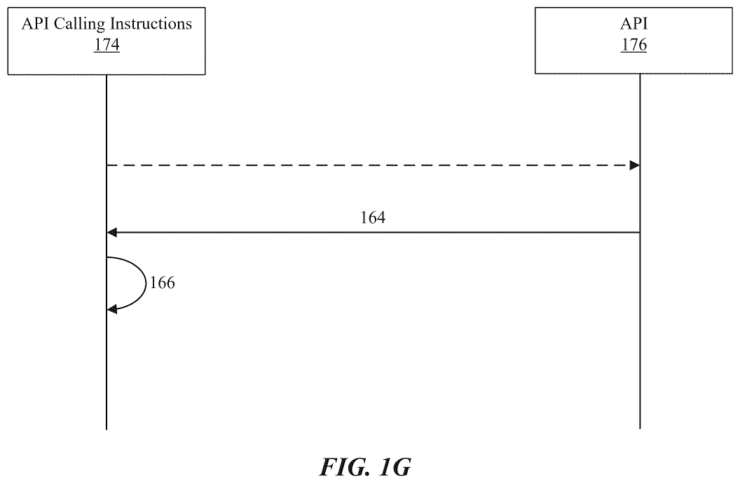

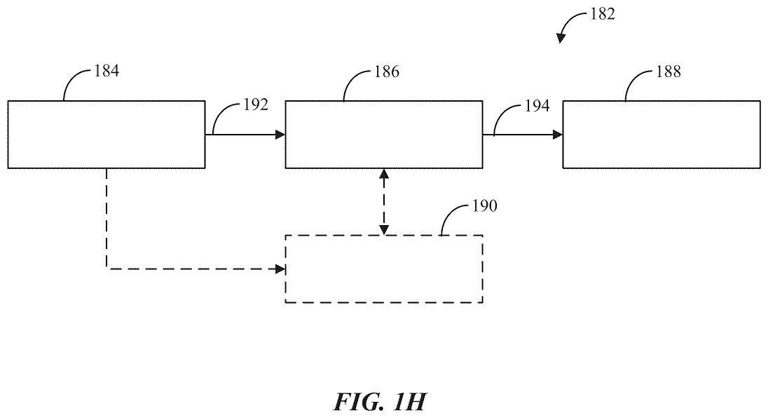

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

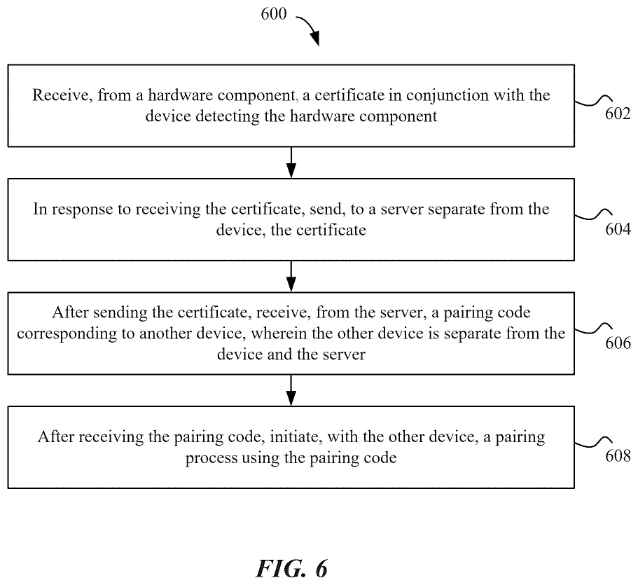

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 600 and/or 700 (FIGS. 6 and/or 7) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

FIG. 1H is a block diagram illustrating a device for pairing with a device in accordance with some embodiments. The block diagram includes device 182 (e.g., a user device, a communal device, an accessory device, or a server) for pairing with a device including first interface 184, process 186, and third interface 188.

In some embodiments, first interface 184 obtains data from various sources (e.g., sensors, cameras, and/or microphones) in communication with and/or included in device 182 indicating environmental conditions. In some embodiments, additional signal processing filters combine the obtained data with additional contextual information derived from user configurations.

In some embodiments, input 192 from first interface 184 is fed to process 186. In such embodiments, process 186 can include one or more learning-based and/or non-learning-based models for perceiving, synthesizing, and/or inferring information. It should be recognized that process 186 can include any suitable number of processes to generate output 194 based on input 192.

In some embodiments, device 182 elects to use other process 190 instead of process 186 to process data in situations where only one modality of data is being processed. Other process 190 can be a non-learning network.

In some embodiments, output from process 186 is provided to second interface 188, where second interface 188 disambiguates recommendations. For example, based on current context and/or default settings provided by a user, second interface 188 can select a subset of recommendations to surface to the user.

It should be recognized that process 186 can include any suitable machine learning model that is well-known or widely available, such as a regression technique, a classification technique, a neural network, and/or a deep learning network. For example, process 186 can include an Artificial Neural Network (ANN), a Convolutional Neural Network (CNN), a Recurrent Neural Network (RNN), an Adversarial Network (GAN), a Reinforcement Learning Model (RLM), an Encoder/Decoder Network, and/or a Transformer-Based Model (e.g., a Bidirectional Encoder Representation from Transformer (BERT), a Generative Pre-trained Transformer (GPT), and/or a multi-modal large language model (LLM)). Additionally or alternatively, it should be recognized that process 186 can be any suitable non-learning process, such as a rule-based system, a heuristic, a decision tree, a knowledge-based system, a statistical or stochastic system, and/or an expert system.

In embodiments where process 186 is a machine-learning based model, process 186 can be trained to perform a function using one or more well-known or widely available training techniques, such as supervised learning, semi-supervised learning, unsupervised learning, and/or a reinforcement learning technique. The training data can include any type of data.

In embodiments where process 186 is a non-learning-based system, process 186 can use a pre-defined set of one or more rules or a pre-defined structure to make a decision based on an input. For example, process 186 can sequentially process each word in an input phrase and count the number of times that the word appears. Process 186 can then prepare a summary using words that appear with the greatest frequency.

In some embodiments, process 186 is deployed as one or more generative models, where content is automatically generated by one or more computer systems in response to a request to generate the content. The automatically-generated content can be generated on-device (e.g., generated at least in part by a computer system at which a request to generate the content is received) and/or generated off-device (e.g., generated at least in part by one or more nearby computer systems that are available via a local network or one or more computer systems that are available via the internet). The automatically-generated content can include visual content (e.g., images, graphics, and/or video), audio content, and/or text content. The automatically-generated content can include deterministically generated content that is generated by one or more computer systems and/or non-deterministically generated content that is generated automatically by one or more computer systems.

In some embodiments, automatically-generated content that is generated using a non-deterministic process is referred to as generative content (e.g., generative images, generative graphics, generative video, generative audio, and/or generative text). In such embodiments, generative content can be generated by an automated process based on a prompt that is provided to the automated process. In some embodiments, the automated process is a Machine Learning (ML) process, such as a process that uses one or more ML models to generate an output based on an input. The ML process can include one or more pre-processing steps to adjust the input before it is used by the one or more ML models to generate an output (e.g., adjustment to a user-provided prompt, creation of a system-generated prompt, and/or ML model selection). In some embodiments, generative content is generated using a non-deterministic process that generates content using one or more automatic steps that include specific rules and/or steps for processing a prompt including one or more non-deterministic steps that introduce one or more novel generative elements into the content that is generated. The ML process can include one or more post-processing steps to adjust the output by a ML model (e.g., passing the ML model output to a different ML model, upscaling, downscaling, cropping, formatting, and/or adding or removing metadata) before the output of the ML model used for other purposes, such as being provided to a different software process for further processing or being presented (e.g., visually or audibly) to a user. The ML process is sometimes referred to as a generative ML process.

A prompt for generating generative content can include one or more of: one or more words (e.g., a natural language prompt that is written or spoken), one or more images, one or more drawings, and/or one or more videos. The ML process can include a neural network, a linear regression, a decision tree, a support vector machine (SVM), a Naive Bayes function, and/or a k-nearest neighbors function. A neural network can include a transformer-based deep neural network, such as a large language model (LLM) that is trained using supervised, unsupervised, reinforcement, and/or other learning techniques. A generative pre-trained transformer model can be a type of LLM that is effective at generating novel generative content based on a prompt. The ML process can use a prompt that includes text to generate either different generative text, generative audio content, and/or generative visual content. The ML process can use a prompt that includes visual content and/or an audio content to generate generative text (e.g., a transcription of audio and/or a description of the visual content). A multi-modal ML process can use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an ML process that include phrasing, a specified style, relevant context (e.g., starting point content and/or one or more examples), and/or a role for the ML process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt can request that a block of text is summarized or rewritten in a different tone, and the output would be generative text that is summarized or written in the different tone. Similarly, a prompt can request that visual content be modified to include or exclude content specified by the prompt (e.g., removing an identified feature in the visual content, adding a feature to the visual content that is described in the prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseudo-random seed content is used as a starting point for creating the generative content). For example when generating an image from a diffusion model, a random noise pattern can be iteratively denoised based on the prompt to generate an image that is based on the prompt. While specific types of ML processes have been described herein, it should be understood that a variety of different ML processes could be used to generate generative content based on a prompt.

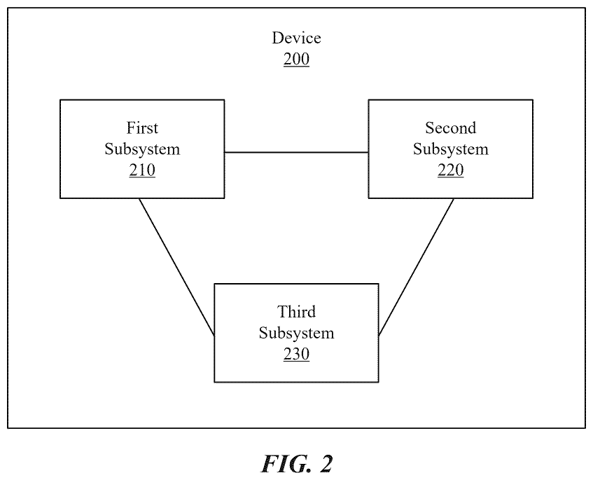

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for pairing with a device. Such techniques are described in the context of a device pairing with another device. It should be recognized that various types of electronic devices can be used with techniques described herein. For example, a mobile phone can pair with an accessory using techniques described herein. In addition, techniques optionally complement or replace other techniques for pairing with a device.

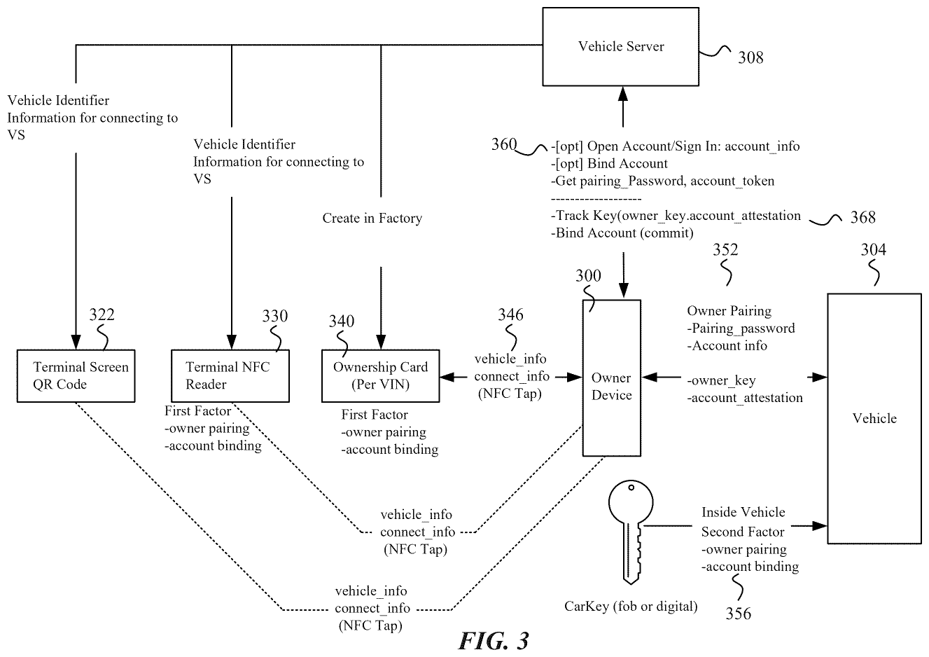

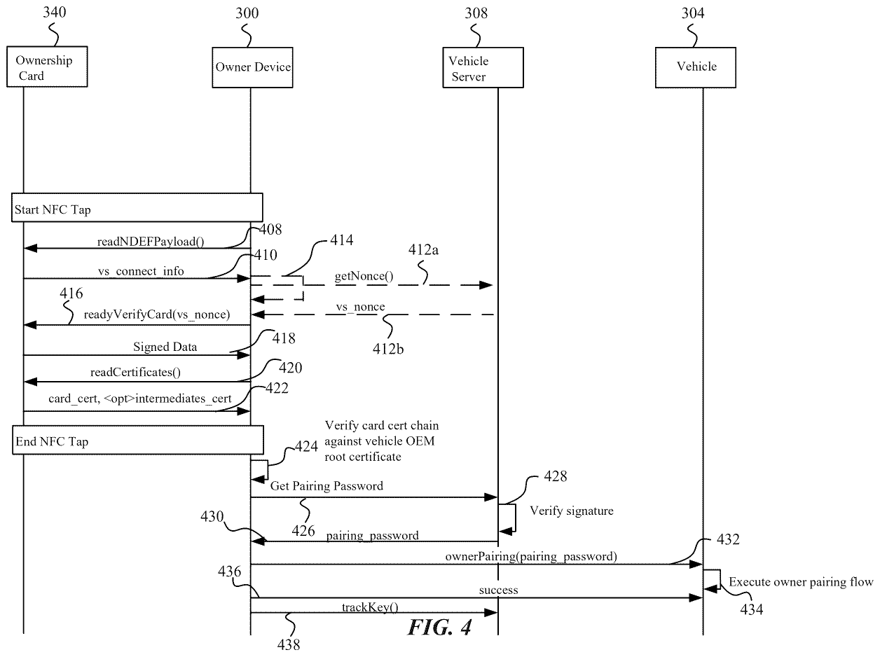

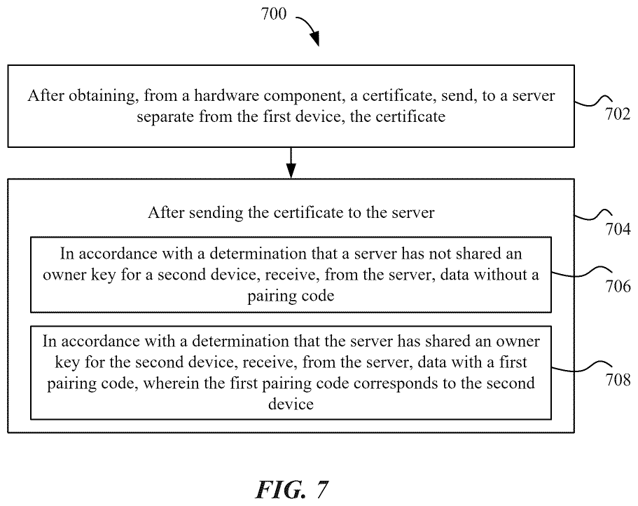

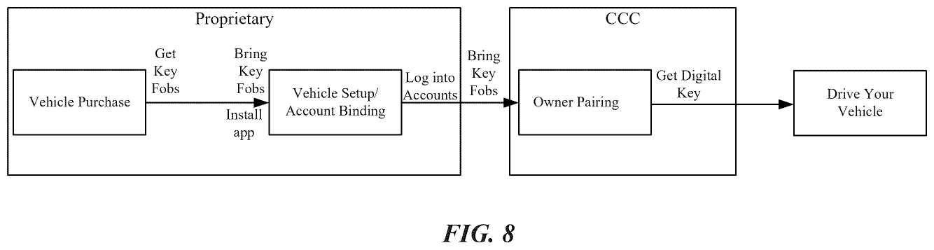

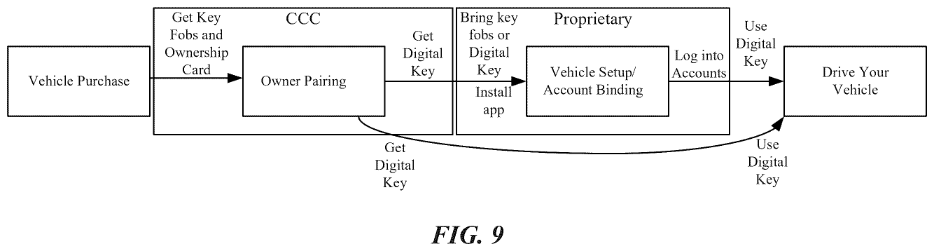

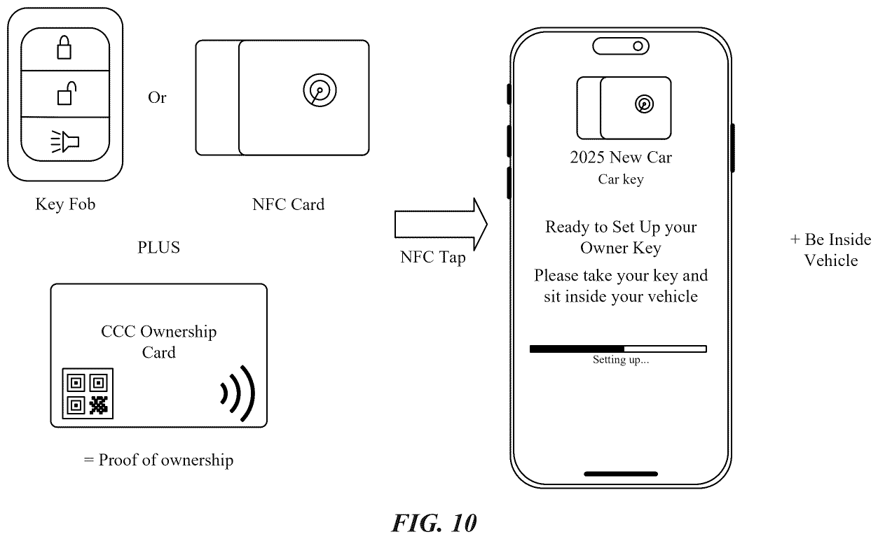

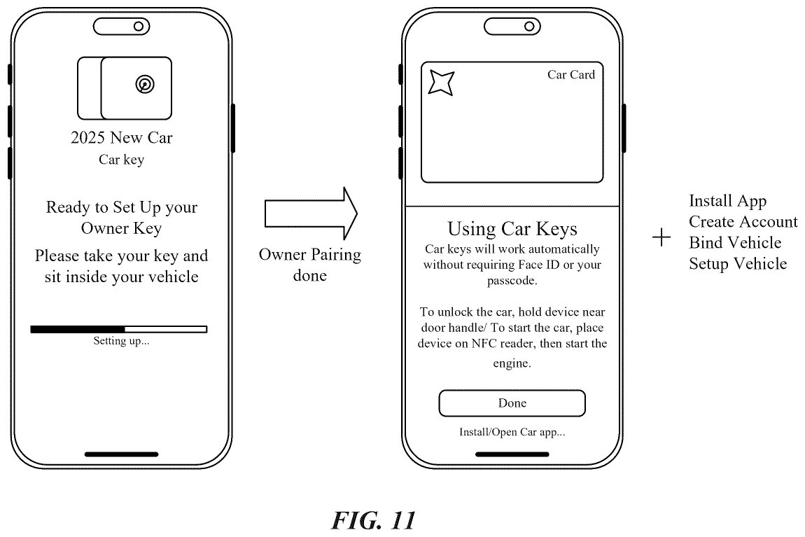

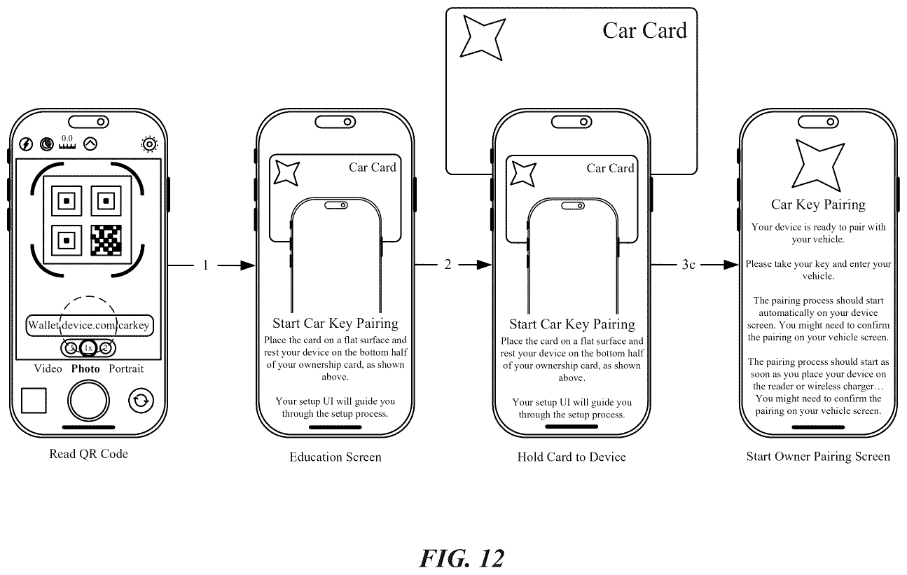

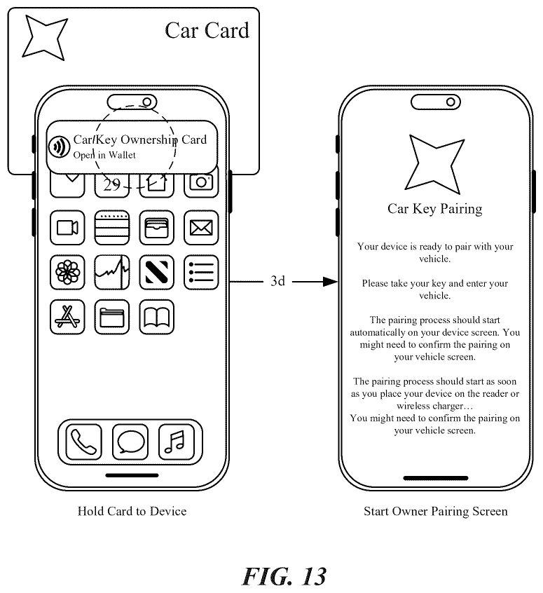

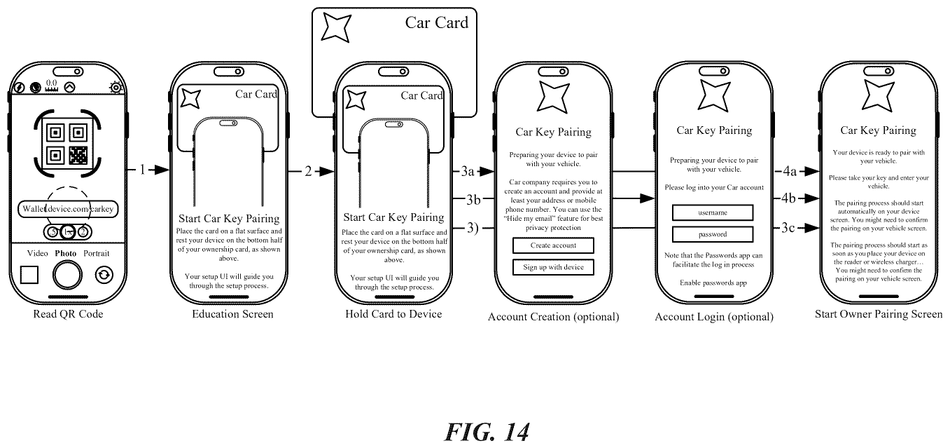

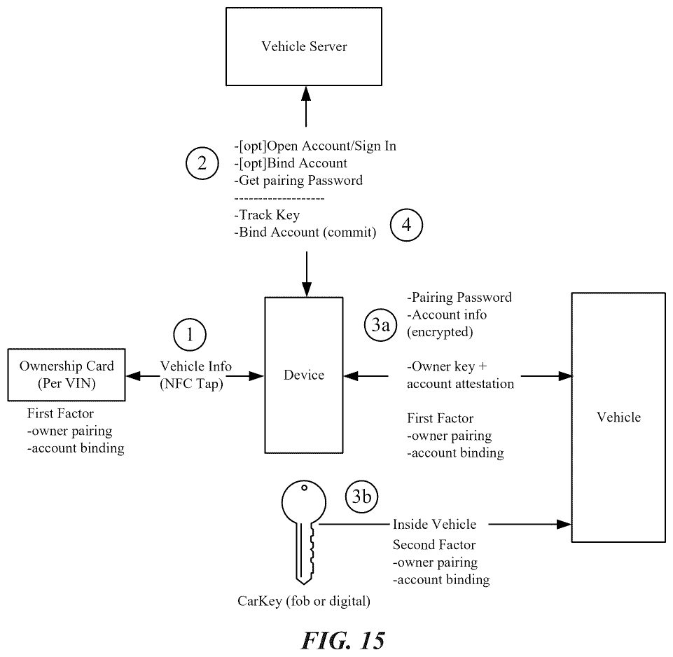

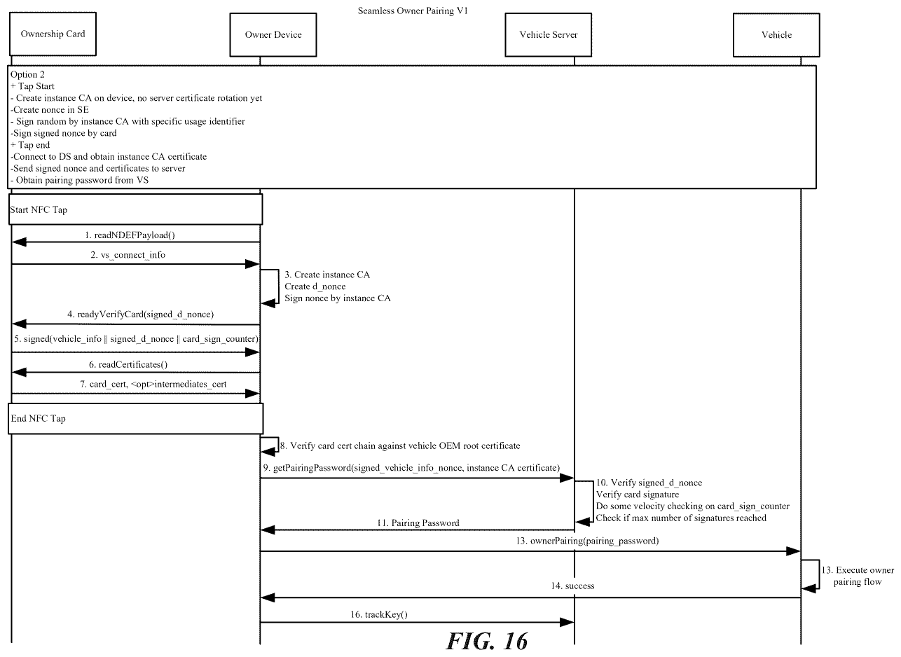

FIG. 3 is a flow diagram illustrating a process of pairing an owner device to a vehicle. The flow diagram is used to illustrate the processes described below, including the processes in FIGS. 6-7.

As illustrated in FIG. 3, the flow diagram includes owner device 300, vehicle server 308, vehicle 304, terminal screen 322, terminal near-field communication (NFC) reader 330, and ownership card 340. In FIGS. 3-5, owner device 300 is a smartphone. It should be recognized that owner device 300 can be other types of devices such as a tablet, a smart watch, a laptop, a communal device, an accessory, a fitness tracking device, and/or a head-mounted display (HMD) device. In some embodiments, owner device 300 includes one or more components and/or features described above in relation to compute system 100 and/or device 200.

In FIGS. 3-5, vehicle 304 is an automobile such as a car, truck, or van. It should be recognized that this is merely exemplary and vehicle 304 can be other types of vehicles such as a train, a plane, and/or a boat. In some embodiments, vehicle 304 is an accessory such as a television, a speaker, and/or a tablet. In FIGS. 3-5, vehicle server 308 is a server that corresponds to (e.g. is owned by and/or created by) a manufacturer of vehicle 304. In some embodiments, vehicle server 308 is in communication with owner device 300. In some embodiments, vehicle server 304 is integrated into vehicle 304. In some embodiments, vehicle server 304 is remote to vehicle 304. In some embodiments, vehicle server 304 is an application server, database server and/or proxy server.

Terminal screen 322 is a screen of a computer system capable of displaying a quick reply code (QR code) used to initiate a pairing process between owner device 300 and vehicle 304. In some embodiments, terminal screen 322 is in communication with vehicle server 308. Terminal NFC reader 330 is a computer terminal that includes a near field communication reader capable of reading and exchanging information with NFC tags and NFC-enabled devices. In some embodiments, terminal NFC reader 330 is in communication with vehicle server 308. As explained in greater detail below, terminal screen 322 and terminal NFC reader 330 are examples of entry points for initiating the pairing process between owner device 300 and vehicle 304.

Ownership card 340 is a piece of hardware that includes a near field communication (NFC) tag. In some embodiments, ownership card 340 is created by an original equipment manufacturer (OEM) of vehicle 304. The OEM creates ownership card 340 by generating a key pair and adding the vehicle identification number (VIN) or another suitable identifier of vehicle 304 to the public key (PK) certificate of ownership card 340. In such embodiments, the PK certificate is known to and/or verifiable by vehicle server 308. In some embodiments, one or more devices in FIG. 3 include one or more components described above with respect to compute system 100 and/or device 200. In some embodiments, the process illustrated in FIG. 3 is performed with fewer, more and/or different components. For example, the process illustrated in FIG. 3 might not include vehicle server 308. In some embodiments, ownership card 340 corresponds to a single vehicle (e.g., vehicle 304). In other embodiments, ownership card 340 corresponds to multiple vehicles

At step 346, owner device 300 detects an NFC chip of ownership card 340 after (or in conjunction with) owner device 300 being placed in close proximity to the NFC chip of ownership card 340. In response to owner device 300 detecting the NFC chip of ownership card 340, owner device 300 obtains information from the NFC chip of ownership card 340. In some embodiments, the information includes information related to vehicle 304 and/or information related to vehicle server 308. For example, the information related to vehicle 304 can be a serial number of vehicle 304, such as a VIN. For another example, the information related to vehicle 304 can include data to be used to communicate with vehicle server 308, such as a uniform resource locator (URL) for connecting to vehicle server 308. In some embodiments, the key pair secures the VIN to obtain a proof that owner device 300 has communicated with ownership card 340 in a secure and non-replayable manner. In some embodiments, owner device 300 obtains a cryptographic blob that is redeemed by vehicle server 308 against a unique owner pairing URL or a unique sharing URL.

Owner device 300 obtaining the information related to vehicle 304 and the information related to vehicle server 308 from ownership card 340 is one example of an entry point for initiating a pairing process between owner device 300 and vehicle 304. Both terminal screen 322 and terminal NFC reader 330 are examples of other types of entry points that device 300 can use to obtain the same or similar information. For example, device 300 can receive, from terminal screen 322, information related to vehicle 304 (e.g., VIN data, one way cryptographic proof, and/or a unique identifier) and/or information related to vehicle server 308 as part of device 300 scanning a quick reply (QR) code displayed by terminal screen 322. In such an example, the cryptographic proof can be defined (e.g., by including the current time stamp and a unique signature of the VIN data to be retrieved in the QR code, or by using Bluetooth, Wifi, and/or 5G). In such an example, terminal screen 322 receives the information related to vehicle 304 and/or the information related to vehicle server 308 from vehicle server 308 before sending the information to device 300. Another example of an entry point for initiating the pairing process between owner device 300 and vehicle 304 is the receipt of a link in a message, such as an Internet message or a short message service (SMS) message. In such an example, an exchange of cryptographic data (346) over Bluetooth, Wifi, or 5G can be initiated in response to selection of the link. As an additional example of an entry point, device 300 can receive the information related to vehicle 304 and/or the information related to vehicle server 308 in response to being in proximity with a NFC chip of terminal NFC reader 330. In such an example, terminal NFC reader 330 receives the information related to vehicle 304 and/or the information related to vehicle server 308 from vehicle server 308 before sending such information to device 300.

At step 360, owner device 300 connects to vehicle server 308 using the information related to vehicle server 308 that owner device 300 obtained at step 346. While owner device 300 is connected to vehicle server 308, owner device 300 sends the information related to vehicle 304 to vehicle server 308. As a response to sending the information related to vehicle 304 to vehicle server 308, owner device 300 receives a pairing password from vehicle server 308. In some embodiments, as a response to sending the information related to vehicle 304 to vehicle server 308, owner device 300 receives a full pairing URL that includes the pairing password. As explained in greater detail below with respect to FIG. 4, the pairing password can be used to pair owner device 300 to vehicle 304. In some embodiments, the pairing password includes a string of alphanumeric characters. In some embodiments, at step 360, vehicle server 308 prompts owner device 300 to create an OEM account or sign into an existing OEM account. In such embodiments, where the OEM account is created and/or signed into, vehicle server 308 binds vehicle 304 and/or the pairing password to the account.

Step 352 represents a first type of pairing process between owner device 300 and vehicle 304. The first pairing process represents a first factor (e.g., single factor) pairing process between owner device 300 and vehicle 304. At step 352, owner device 300 sends the pairing password and account information to vehicle 304. Upon receipt of the pairing password and account information, vehicle 304 signs the data and sends the data back to owner device 300 as a token. Owner device 300 sends the token to vehicle server 308 as a proof that vehicle 304 knows the account that vehicle 304 is bound to. After vehicle 304 receives the pairing password, the pairing password is used to pair owner device 300 to vehicle 304. As part of the first type of pairing process, vehicle 304 signs an account token that is used as part of an opaque attestation. In some embodiments, the pairing password is used together with a verifier of vehicle 304 to create a secure channel following a PAKE (password authenticated key exchange) protocol. In such embodiments, the pairing password is used on owner device 300 through a cryptographic operation.

Step 356 represents a second type of pairing process between owner device 300 and vehicle 304. The second type of pairing process is an alternative pairing process of owner device 300 and vehicle server 308 than the first type of pairing process. The second type of pairing process represents a two factor (e.g., multi-factor) pairing process. At step 356, vehicle 304 receives the pairing password and the account information from owner device 300 and vehicle 304 detects the presence of an additional credential within vehicle 304. In some embodiments, the additional credential is a physical vehicle key or vehicle fob that corresponds to (e.g., is configured for) vehicle 304. In some embodiments, the additional credential is a digital car key that corresponds to vehicle 304. After receiving the pairing password and detecting the additional credential and upon a successful pairing of vehicle 304 and owner device 300, vehicle 304 sends a digital credential to owner device 300. As part of the pairing process, vehicle 304 signs an account token that is used as part of an opaque attestation.

At step 368, owner device 300 sends a key tracking request to vehicle server 308. The key tracking request includes the signed account token. Owner device 300 sends the token to vehicle server 308 as proof that vehicle 304 knows the account that vehicle 304 is bound to. In response to receiving the request, vehicle server 308 binds the account to vehicle 304 and/or the digital credential and registers the digital credential with vehicle 304. In some embodiments, the binding of the account to vehicle 304 is achieved via a telematics link that vehicle server 308 creates with vehicle 304. Binding the account to vehicle 304 using the telematics link reduces the requirement for vehicle 304 to be online.

FIG. 4 is a swim lane diagram illustrating a process of pairing a device to a vehicle. As illustrated in FIG. 4, the swim lane diagram includes ownership card 340, owner device 300, vehicle server 308, and vehicle 304. The flow diagram is used to illustrate the processes described below, including the processes in FIGS. 6-7.

At step 408, owner device 300 is brought in close proximity (e.g., 0.5-12 inches) of the NFC tag of ownership card 340 (“tapping” ownership card 340). In response to being brought in close proximity to the NFC tag of ownership card 340, owner device 300 detects and powers on the NFC tag of ownership card 340 by creating an electromagnetic field. In some embodiments, in response to being brought in close proximity to the NFC tag of ownership card 340, owner device 300 displays a user interface with instructions on how to pair owner device 300 to vehicle 304. As explained above, “tapping” owner device 300 with ownership card 340 is one example of an entry point for initiating the process of pairing owner device 300 and vehicle 304. The process of pairing owner device 300 and vehicle 304 can be initiated in other manners such as by owner device 300 scanning a Quick Reply (QR) code.

In some embodiments, while the NFC tag of ownership card 340 is powered on, the NFC tag and owner device 300 establish a communication channel. After the communication channel has been established, owner device 300 requests, from ownership card 340, a URL (e.g., the information corresponding to vehicle server 308 described above) via the communication channel. The URL corresponds to (e.g. links to and/or provides access to) vehicle server 308. In some embodiments, owner device 300 requests other information identifying vehicle server 308. In some embodiments, as part of establishing the communication channel, owner device 300 displays an indication (e.g., a banner and/or notification) that the communication channel has been established.

In some embodiments, while the NFC tag of ownership card 340 is powered on, owner device 300 transmits identifying information of owner device 300 to the NFC tag via the communication channel. For example, in response to detecting the NFC tag of ownership card 340, owner device 300 transmits, to ownership card 340, a serial number, a random value generated by owner device 300, a random value generated by vehicle server 308, an instance CA identifier or other stable or mutable identifier of owner device 300,and/or IP address of owner device 300. In some embodiments, the random value generated by owner device 300 includes time information.

At step 410, after receiving the request for the URL, ownership card 340 sends, to owner device 300 the URL. Upon receipt of the URL, owner device 300 automatically opens the URL in an application that is installed on owner device 300. In some embodiments, data corresponding to the URL is embedded within the NFC tag of ownership card 340 when ownership card 340 is manufactured. In other embodiments, vehicle server 308 sends the data corresponding to the URL to the NFC tag of ownership card 340 and/or to ownership card 340 prior to owner device 300 being brought in close proximity to the NFC tag of ownership card 340. In some embodiments, a PK certificate of ownership card 340 includes the URL.

Steps 412a and 412b represent a first process of owner device 300 obtaining a nonce using the URL. At step 412a, owner device 300 uses the URL to request a nonce from vehicle server 308. At step 412b, after receiving the request from owner device 300, vehicle server 308 sends the nonce to owner device 300. In some embodiments, the nonce is valid for a predetermined period of time (e.g., 15-60 seconds). In some embodiments, the nonce is fetched when owner device 300 detects the NFC tag of ownership card 340. For example, when a QR code of ownership card 340 is scanned prior to owner device 300 detecting the NFC tag of ownership card 340, the information included in the QR code allows owner device 300 to pre-fetch the nonce from vehicle server 308. In some embodiments, vehicle server 308 creates the nonce in response to receiving the request for the nonce from owner device 300. In some embodiments, the nonce is already stored on vehicle server 308 when vehicle server 308 receives the request from owner device 300 for the nonce. In some embodiments, a device other than vehicle server 308 creates the nonce. In such embodiments, other cryptographic tools that achieve similar verifiability, uniqueness, and non-replay characteristics as a nonce can be used.

Step 414 represents an alternative manner in which owner device 300 can obtain a nonce. At step 414, instead of requesting, from vehicle server 308, the nonce, owner device 300 creates the nonce. As part of creating the nonce, vehicle server 308 creates an identifier of a certificate authority. Once the nonce is created, owner device 300 signs the nonce. When owner device 300 creates the nonce, vehicle server 308 relies on the fact that owner device 300 does not re-use a previously used nonce. Vehicle server 308 keeps a deny list for all nonces previously used to avoid the reuse of a nonce. Alternatively, vehicle server 308 can store signature counters that it receives and vehicle server 308 approves a signature that has the same or lower counter value of stored signatures.

At step 416, after receiving the nonce (or after creating the nonce), owner device 300 requests, from ownership card 340, signed data that includes the nonce. As part of requesting the signed data, owner device 300 writes the nonce to ownership card 340. At step 418, in response to receiving the request for the signed data, ownership card 340 sends, to owner device 300, signed data. The signed data includes information related to vehicle 304, the nonce, and/or a counter. For example, the signed data can include identifying information of vehicle 304 such as a vehicle identification number (VIN) and/or model of vehicle 304. In some embodiments, the signed data includes the identifier of owner device 300 that owner device 300 sent to ownership card at step 408. In some embodiments, ownership card 340 is connected to vehicle server 308. In such embodiments, ownership card 340 receives the data included in the signed data from vehicle server 308 prior to ownership card 340 receiving the request for the signed data from owner device 300. In some embodiments, owner device 300 cannot read and/or access the signed data after owner device 300 receives the signed data.

At step 420, after receiving the signed data, owner device 300 requests, from ownership card 340, card data so that authenticity of ownership card 340 can be verified. At step 422, in response to receiving the request for the card data, ownership card 340 sends to owner device 300 the card data so that owner device 300 can verify the authenticity of ownership card 340. In some embodiments, the card data includes a serial number of ownership card 340, a date of creation of ownership card 340, and/or an identifier of the NFC tag of ownership card 340. In some embodiments, the card data includes a public key used to verify the signature of the signed data.

Of note, steps 408-422 occur while owner device 300 is in close proximity to the NFC tag of ownership card 340 (e.g., owner device 300 is “tapping” the NFC tag of ownership card 340). In some embodiments, performance of one or more of steps 408-420 is suspended based on a determination that owner device 300 is no longer in close proximity to the NFC tag of ownership card 340. In some embodiments, after (e.g., or while) one or more steps of 408-422 is suspended, the one or more steps of 408-420 are resumed based on a determination that owner device 300 is again in close proximity to the NFC tag of ownership card 340. In some embodiments, steps 408-422 are combined or occur in a different order than the order described above. For example, owner device 300 can obtain the card data prior to requesting the signed data.

At step 424, owner device 300 verifies the card data received at step 420 against a root certificate of vehicle 304. At step 426, based on a successful verification of the card data against the root certificate of vehicle 304, owner device 300 requests, from vehicle server 308, a pairing password. In some embodiments, owner device 300 does not request, from vehicle server 308, the pairing password based on an unsuccessful verification of the card data against the root certificate of vehicle 304. In some embodiments, owner device 300 requests the pairing password using the URL that is received at step 410. In some embodiments, owner device 300 requests the pairing password using a channel that is different than the URL that is received at step 410.

At step 426, as part of requesting the pairing password, owner device 300 sends, to vehicle server 308, the signed data that owner device 300 receives at step 418. In some embodiments, when owner device 300 creates the nonce (and does not receive the nonce from vehicle server 308), owner device 300 transmits the identifier of the certificate authority as part of requesting the pairing password. In some embodiments, owner device 300 sends the identifier of owner device 300 to vehicle server 308 as part of sending the signed data to vehicle server 308. In some embodiments, the identifier of owner device 300 and the signed data are included in a signature when sent to vehicle server 308.

At step 428, in response to receiving the signed data (e.g., and/or in response to receiving the request for the pairing password), vehicle server 308 verifies the signed data. For example, vehicle server 308 can verify that the nonce that is included in the signed data is the nonce that vehicle server 308 sent to owner device 300 at step 414, that the vehicle information included in the signed data is the vehicle information that corresponds to vehicle 304, and/or that the counter is not above a threshold or was previously used. In some embodiments, when owner device 300 creates the nonce, vehicle server 308 verifies a signature of ownership card 340 as part of verifying the signed data.

At step 430, based on the successful verification of the signed data, vehicle server 308 sends, to owner device 300, the pairing password. In some embodiments, the identifier of owner device 300 is bound to the pairing password when the pairing password is sent to owner device 300. In some embodiments, vehicle server 308 sends, to owner device 300, the pairing password based on the successful verification of the signed data and based on a determination that vehicle server 308 has previously shared, with another computer system, a digital key of vehicle 304. In some embodiments, the pairing password is a series of alphanumeric characters. In some embodiments, the pairing password is a fragment of a URL. In such embodiments, when the URL is accessed, owner device 300 redirects the URL to a framework that extracts the pairing password from the URL. In some embodiments, the URL is used to transport the parameters to be interpreted by the framework. In some embodiments, when the URL is accessed, owner device 300 adds a digital certificate of the pairing password to an application that is installed on owner device 300.

At step 432, in response to receiving the pairing password, owner device 300 sends the pairing password to vehicle 304. In some embodiments, this communication contains vehicle 304 OEM account data. In some embodiments, the pairing password is used together with a verifier of vehicle 304 to create a secure channel following a PAKE (password authenticated key exchange) protocol. In such embodiments, the pairing password is used on owner device 300 through a cryptographic operation. In some embodiments, owner device 300 sends the identifier of owner device 300 to vehicle 304 as part of sending the pairing password to vehicle 304. In some embodiments, the identifier of owner device 300 is bound to the pairing password when the pairing password is sent to vehicle 304. In some embodiments, owner device 300 sends the signed data (e.g., the data owner device 300 receives at step 410) to vehicle 304 as part of sending the pairing password to vehicle 304.

In some embodiments, owner device 300 sends the pairing password to vehicle 304 in response to detecting an input that corresponds to selection of a pairing user interface element that is displayed by owner device 300. In some embodiments, owner device 300 sends the pairing password to vehicle 304 in response to being placed within a predetermined distance (e.g., 1-20 feet) threshold of vehicle 304. In some embodiments, owner device 300 sends the pairing password to vehicle 304 in response to receiving a request from vehicle 304 for the pairing password. In some embodiments, as part of sending the pairing password to vehicle 304, owner device 300 displays a user interface that corresponds to the pairing process between owner device 300 and vehicle 304. For example, as part of sending the pairing password to vehicle 304, owner devices displays a user interface that includes instructions for pairing owner device 300 to vehicle 304.

At step 434, in response to receiving the pairing password, vehicle 304 executes (e.g., initiates) an owner pairing flow between vehicle 304 and owner device 300 using the pairing password. During the owner pairing flow, an account token is signed by vehicle 304. Based on a determination that the owner pairing flow process is successful, vehicle server 308 sends a digital credential to owner device 300. In such embodiments, receipt of the digital credential grants owner device 300 with entitlements to controlling one or more operations of vehicle 304. For example, while owner device 300 has the digital credential, owner device can 300 unlock one or more doors of vehicle 304. In some embodiments, based on a determination that the owner pairing flow process is successful, owner device 300 displays a user interface that indicates that owner device and vehicle 304 are paired.

At step 436, based on the successful execution of the owner pairing flow, owner device 300 sends, to vehicle 304, confirmation data. The confirmation data indicates that owner device 300 and vehicle 304 are paired. In some embodiments, after owner device 300 sends the confirmation data to vehicle server 308, owner device 300 receives, from vehicle server 308, a signature and sends the signature to vehicle 304. In some embodiments, after owner device 300 and vehicle 304 are successfully paired, vehicle 304 sends, to owner deice 300, confirmation data that indicates that owner device 300 and vehicle 304 are successfully paired. In such embodiments, owner device 300 sends the confirmation data that is received from vehicle 304 to vehicle server 308 as a proof that vehicle 304 knows the account that vehicle 304 is bound to.

At step 438, owner device 300 sends, to vehicle server 308, a request to bind the digital credential to vehicle 304. In some embodiments, the request to bind the digital credential to vehicle 304 includes the account token. In some embodiments, when owner device 300 creates the nonce on device, owner device 300 sends, to vehicle server 308, the identifier of the certificate authority as part of requesting that the digital credential be bound to vehicle 304.

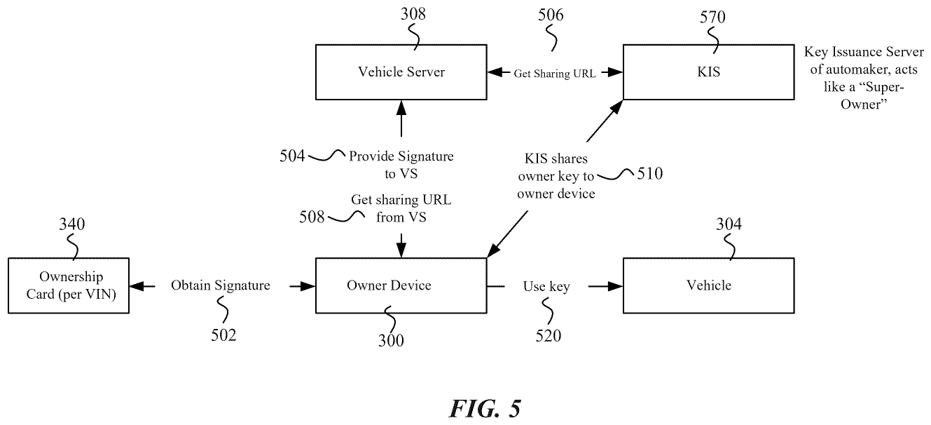

FIG. 5 is a block diagram illustrating a process of sharing a digital credential between an authorized entity (e.g., a vehicle server) and a device in accordance with some embodiments. The flow diagram is used to illustrate the processes described below, including the processes in FIGS. 6-7. FIG. 5 includes ownership card 340, ownership device 300, vehicle server 308, key issuance server 570, and vehicle 304. In some embodiments, key issuance server 570 corresponds to a manufacturer of vehicle 304. For example, the owner of key issuance server 570 is the manufacturer of vehicle 304. In some embodiments, key issuance server 570 is integrated into vehicle 304. In some embodiments, key issuance server 570 is remote to vehicle 304. In some embodiments, key issuance server 570 is an application server, database server and/or proxy server. In some embodiments, the key issuance server 570 corresponds to (e.g., is created and/or owned by) a manufacturer of vehicle 304. For example, the owner of key issuance server 570 is the manufacturer of vehicle 304.

In some embodiments, key issuance server 570 acts as a super owner of vehicle 304. In some embodiments, a super owner is an entity (e.g., a physical entity and/or digital entity) that initially owns vehicle 304 after vehicle 304 is manufactured. In some embodiments, a super owner is an entity with certain privileges with respect to the ability of assigning rights to vehicle 304. In some embodiment, a super owner is the original equipment manufacturer (OEM) of vehicle 304. In some embodiments, a manufacturer of vehicle 304 makes key issuance server 570 a super owner of vehicle 304 after vehicle 304 is manufactured. In some embodiments, because key issuance server 570 is a super owner of vehicle 304, key issuance server 570 stores a digital key for vehicle 304. As discussed in greater detail below, because key issuance server 570 stores a digital key for vehicle 304, key issuance server 570 is able to share a digital key for vehicle 304 with other computer systems. In some embodiments, a manufacturer of vehicle 304 creates and issues the digital key. In some embodiments, key issuance server 540 receives a digital key for vehicle 304 upon vehicle 304 being manufactured. In some embodiments, vehicle server 308 sends the digital key to key issuance server 570.

At step 502, owner device 300 is in close proximity (e.g., 0.5-12 inches) of the NFC tag of ownership card 340 (e.g., owner device 300 is “tapping” ownership card 340). While ownership device 300 is in close proximity of owner device 300, owner device 300 receives, from ownership card 340, signed data. As explained above, the signed data can include identifying information of vehicle 304 such as a VIN and/or model of vehicle 304. In some embodiments, owner device 300 is a smartphone, smartwatch or tablet. At step 504, after receiving the signed data, owner device 300 sends the signed data to vehicle server 308.

At step 506, a determination is made that vehicle server 308 has not previously shared a digital key for vehicle 304. Based on the determination that vehicle server 308 has not previously shared a digital key for vehicle 304, vehicle server 308 requests, from key issuance server 570, a sharing password URL. At step 506, in response to receiving the request, key issuance server 570 sends, to vehicle server 308, the sharing password URL. At step 508, owner device 300 receives the sharing password URL from vehicle server 308. The contrast of FIG. 4 and FIG. 5 highlights the different types of URLs that owner device 300 receives as a result of owner device 300 communicating with vehicle server 308. More specifically, when vehicle server 308 has not previously shared a digital key for vehicle 304, owner device 300 receives a sharing URL at step 508. To the contrary, when vehicle server 308 has previously shared a digital key for vehicle 304 and when vehicle 304 supports sharing in a chain, owner device 300 receives a pairing URL at step 508. In some embodiments, sharing in a chain is a concept of sequential or multi-hop sharing of vehicle access. In some embodiments, when vehicle server 308 has previously shared a digital key for vehicle 304, owner device 300 receives the sharing URL from vehicle server 308 at step 508. In some embodiments, when vehicle server 308 has not been previously shared a digital key for vehicle 304, owner device 300 receives the pairing URL from vehicle server 308 at step 508 In some embodiments, when vehicle server 308 has previously shared a digital key for vehicle 304 and when vehicle 304 does not support sharing in a chain, owner device 300 receives a pairing URL at step 508. In some embodiments, if vehicle 304 does not support sharing in a chain, owner device 300 receives a pairing URL from vehicle server 308 at step 508, irrespective of whether vehicle server 308 has previously shared a digital key for vehicle 304. In some embodiments, when vehicle server 308 has not been previously shared a digital key for vehicle 304, business (e.g. a car dealership, auto loan business) and/or security policies can dictate whether a pairing URL or sharing URL is provided to owner device 300 at step 508.

At step 510, based on owner device 300 accessing the sharing password URL, owner device 300 receives, from key issuance server 570, a digital key for vehicle 304. Owner device 300 is granted various entitlements with respect to the operation of vehicle 304 based on owner device 300 having the digital key. For example, based on owner device 300 having the digital key, owner device 300 can power on vehicle 304. In some embodiments, the entitlements that owner device 300 receives as a result of receiving a digital key are different from the entitlements that owner device 300 receives as a result of pairing with vehicle 304 (e.g., as described above with respect to FIG. 4). For example, based on owner device 300 device being paired with vehicle 304, owner device 300 can share access to a digital key of vehicle 304 with other devices while owner device 300 is not able to share the shared key with other devices. In some embodiments, owner device 300 does not pair to vehicle 304 when the digital key is received and/or used. For example, owner device 300 does not pair to vehicle 304 when the digital key is used to unlock vehicle 304. In some embodiments, owner device 300 receives the same entitlements when owner device 300 is paired with vehicle 304 as when owner device 300 receives the digital key.

At step 520, owner device 300 uses the digital key to gain access to vehicle 304. For example, owner device 300 uses the digital key to unlock one or more doors of vehicle 304. In some embodiments, owner device 300 uses the digital key to or control one or more functions of vehicle 304. For example, owner device 300 uses the digital key to power on vehicle 304 and/or control a heating and/or colling function of an air conditioner of vehicle 304.

### Seamless Owner Pairing—Architecture (Disclosure)

### Problem Statement (From One-Pager)

The process of provisioning a digital key on the owner's phone after purchasing a car is very complicated today. Especially if compared it to the process of getting key fob at end of the vehicle purchase transaction.

To reach owner pairing most OEMs require mandatory OEM account enrollment and app installation; the starting point for owner pairing is not always easy to find in OEM app or email, especially if users are not aware of the feature; users might have to prove ownership several times: to buy the vehicle, to set up the OEM account and to start owner pairing; and unclear process for co-owners to obtain key (e.g. initiating OP again vs. sharing from owner).

No automaker has yet fulfilled the MFi requirement of not requiring a vehicle account to set up car keys. The reason is that today's Car Connectivity Consortium (CCC) specification requires automakers to have a secure communication channel with the owner to deliver the starting point of owner pairing (a unique URL and temporary password)*. To address this requirement, automakers have integrated the car key setup at the end of their existing account onboarding processes. *CCC Specification: “The [pairing] password should be provided to the owner through the Vehicle OEM account, protected by the login credentials known only by the owner.”

This creates an ecosystem in which car owners have to go through non-standardized flows in order to reach the standardized owner pairing flow in Wallet. In most cases, they also need to give away personal identifiable information, not because it is required for the use of digital car keys, but because it's part of the automaker's onboarding process.

Rather, the setup flow for digital car key should be no more onerous than for obtaining a traditional key fob.

### Feature Proposal

There should be a simplified and pure digital car key setup flow that is isolated from other automaker proprietary processes to enable the an onboarding experience for vehicle owners wanting to use digital car keys. Users shall be able to invoke this flow without pre-conditions once the vehicle is purchased and they shall be aware that this flow alone is sufficient to use digital car keys.

In addition, automakers should be encouraged to build the entry point into their own ecosystem on top of this flow, leveraging its ease of use and inherent security properties. However, this should be optional for users and clearly communicated as such.

The proposed setup flow, in some embodiments, meets the following requirements: User-Friendly: Be simple, intuitive, and consistent with familiar user experiences; Independence: Eliminate the need for automaker-specific preconditions; Security: Provide a level of security that is equal to or greater than existing flows; Privacy: Conserve privacy of the car key users; Discoverability: Offer an additional avenue for users to discover the car key feature; and Modularity (Optional): Allow for optional integration as a foundational component for automaker-specific processes. Owner key setup should be started after obtaining an ownership card together with the key fob(s) for the vehicle. Possession of the ownership card and one key fob are considered sufficient proof of ownership. Tapping the ownership card to the device is considered an entry point, although it's not very well known by users nowadays.

A QR code and/or a pictogram, printed on the ownership card, provide additional education to the user. This same approach can also be used with NFC-enabled dealer devices, allowing users to tap their mobile phone to the dealer's device instead of directly to the ownership card.

This idealistic but challenging proposition has to be discussed with selected OEMs to learn if there are regulatory, legal or structural constraints that may require some carefully considered deviations. With those learnings we have to debate if and how we might adjust the flow to accommodate valid exceptions in our architecture.

A digital owner key has an advantage compared to a key fob, which is that it is strongly bound to the device for further usage. This binding can be leveraged by the vehicle OEM as a proof of ownership for further, OEM-proprietary setup flows (e.g. account creation or login, binding the vehicle into the account, etc.), because the two factors for owner pairing (possession of ownership card and possession of key fob) are translated into possession of owner device and ability to unlock successfully through various credentials such as a passcode.

### Overview of Proposed Setup Flow:

User Obtains Ownership Card: The user receives a physical ownership card containing a secure element along with their key fobs; OP Initiation: The user taps the ownership card to their mobile phone (or scans a QR code on the card which leads to further instructions). Digital Key Provisioning: The digital car key is provisioned to the user's device using the existing owner pairing flow inside the vehicle; Confirmation: The user is notified of successful key setup. Education about how to use and share car keys is provided and optionally vehicle's software interface can be paired automatically; and Option to enroll in automaker's ecosystem: The user is offered an easy way to onboard into the automaker's ecosystem to be able to use proprietary services. Downloading the automaker app might also be offered. This can be easily dismissed/skipped by the user.

This proposal inverts proprietary and CCC flow, and adds the ownership card to CCC as a standardized means to start owner pairing without other pre-conditions than required for obtaining the key fob:

### Discovery/Entry Points

Users should be able to discover the owner pairing flow using methods they are already familiar with when setting up other, non vehicle-related features on their mobile device. Examples are: Scanning a QR code on a document, plastic card or accessory (pay in restaurant, home kit set up, etc.); Tapping a NFC plastic card to a mobile device (tap-to-provision, tap-to-pay); Half-screen user interface; “+” button in wallet application to add a card to wallet application (transit, driver's license, etc.); Taking a photo of a plastic card number (credit card provisioning, ID scan for travel, etc.); Successful pairing of vehicle's software interface; Scanning a QR code generated by the dealer or other authorized person on their secure terminal; and Tapping an NFC reader connected to the secure dealer terminal.

For vehicle owner key setup several entry points should be supported as listed here: Scan QR code printed on ownership card that Triggers UI that explains how to start owner pairing by holding the card to the device and Should provide a proof of physical possession (e.g. CVV) that unlocks NFC interaction with the card to avoid NFC relay attacks. Scan QR code provided in a secret document. Instead of CVV a secret PIN code could be provided as a QR code printed value on a separate document (e.g. scratch-to-show) handed over at vehicle purchase or sent separately. QR code triggers owner pairing UI and provides a secret to be verified later (e.g. as card PIN). Clear value prints the same secret that has to be entered in the mobile device UI if user starts by holding the ownership card to the device. Finish (first) pairing with the vehicle. Triggers UI (e.g. half-screen user interface) that explains how to start owner pairing by holding the card to the device. Could provide an element (e.g. same as CVV or PIN in QR code) to unlock interaction with ownership card. Scan embossed number on ownership card with camera. Start wallet provisioning flow (no need to hit “+” button). Enter CVV on card manually. Opening wallet and tapping on “+” button. Select automaker and then “Car Key Setup” option and explains how to hold the ownership card to the device (if received at vehicle purchase). Allows to pick up an interrupted owner pairing flow that has started e.g. by NFC-tap with the ownership card to the owner device. Approaching the vehicle after having started owner pairing by one of the methods above but having dismissed the UI on the device. Show a user interface when close by or inside of vehicle that allows to finalize owner pairing flow (automatically or after hitting a confirmation button. Explain to bring a key fob (if still outside of a locked vehicle) and go inside of the vehicle to continue. Scan QR code generated by the dealer or other authorized person on their secure terminal. Dynamic QR code contains secure vehicle identification data that can be used to start the owner pairing process.

### Possible Obstacles

Vehicle OEMs might require an account creation and/or ask the user to accept their T&Cs before the SPAKE verifier can be provisioned to the vehicle. At least for the first purchase of the vehicle, a verifier could be pre-provisioned during production. Vehicle OEMs might have issues to modify their system to accommodate owner pairing without a prior account setup. We will work with them to explain the advantages of our proposition.

### User Journey—Variant 1

After purchase (new or pre-owned, paid cash, card or via online account) the new vehicle owner obtains one (or more) key fobs or NFC cards or other form factors, PLUS the NFC ownership card. Tapping the ownership card to any eligible device of the owner starts owner pairing, which completes only when the owner is inside the vehicle. This can happen via BT or NFC as described in the CCC specification. To be inside the vehicle the owner requires a key fob or NFC card to unlock. No other conditions are required. NFC cards might need to be tapped onto the interior reader to confirm they are inside the vehicle. The vehicle UI might show a confirmation UI to start OP.

Once owner pairing is done, the device UI can offer a path into the vehicle OEM-proprietary ecosystem, for example by providing a link to open or install the OEM app. The digital owner key on the device can be leveraged as proof of ownership for further actions, such as linking an OEM account to the vehicle by signing some account information sent by the account server with the private key. This could provide a truly password-free login mechanism from the keyholder device. Login from other devices would still require “traditional” credentials such as username/password or a passkey. For setup flows in the vehicle possibly also a shared key (optional plus a key fob) can be used as proof to authorize the setup flow. This is much better than traditional ways where users need to prove e.g. via ID card upload and face verification that they are the owner of the vehicle.

### User Journey—Variant 2

The user scans the QR code on the ownership card to learn how to present the card to the device: If the user already knows how to tap a plastic card, then they can just start by holding the card to the reader: There is no need to manually tap on the notification triggered by the tap to the ownership card for the further NFC interaction. The device can automatically redeem the URL that is obtained through the NDEF interaction at the start of the NFC flow between device and card, provided that this URL is standardized.

If the vehicle OEM requires an account setup, then the following flows can be used: Create new account “on the fly” with a sign in feature; Log into existing account using a Passwords app, requiring a credential+autofill; No account required (same as above). Note that details of account creation and setup are not shown.

We expect #3 to be a transitory flow until the vehicle OEMs have completely moved to our proposed flow that does not require account creation upfront for a successful owner pairing. One alternative could be that vehicle OEMs create an “anonymous account” for the vehicle that is pre-bound to the ownership card and the vehicle, which will help to provision the SPAKE verifier through the telematics link, if required. In the proprietary setup flow after successful owner pairing, this account could be made accessible through temporary credentials that the owner can modify to make it their account.

### High Level Concept—Ownership Card

Ownership card is factory-paired with vehicle based on and ECC public key pair in a way that vehicle server knows the public key provisioned to the card and can verify digital signatures made by the card. Vehicle server provisions SPAKE verifier in vehicle even before vehicle is paired to OEM account. An anonymous account should be created if required and made available to the user with temporary credentials. (1), (2) Possession of ownership card and reaching out to the VS, with optional signing into an OEM account, provides access to pairing password on the vehicle server. Note that the vehicle might be bound to the account based on the ownership card now. Otherwise account binding should occur later during key tracking. (3a), (3b) Pairing password plus one key fob allows to start owner pairing with vehicle. Account token is signed by the vehicle during owner pairing, this can be part of the opaque attestation. (4) Signed account token in key tracking request completes account binding on vehicle server side

### High Level Concept—Dealer Terminal

Vehicle server provisions SPAKE verifier in vehicle even before vehicle is paired to OEM account. An anonymous account should be created if required. This process requires that the vehicle is already bound to the owner account before provisioning starts. The dealer terminal is connected to the automaker server online (or has obtained the necessary data ahead of time for the specific vehicle if necessary). It provides signed vehicle information to the device that is tapped or that scans the QR code. As QR code does not allow data roundtrips other security elements such as a very limited timestamp should be included to avoid copy and later redemption. The dealer terminal provided information might directly contain the pairing password required to set the device into pairing mode, so that the device does not need to reach out the vehicle server before owner pairing (omit 2). (3a), (3b) Pairing password plus one key fob allows to start owner pairing with vehicle. Account token is signed by the vehicle during owner pairing, this can be part of the opaque attestation. (4) Signed account token in key tracking request completes account binding on vehicle server side

### Architecture

### Building Blocks

### QR Code or App-Clip Code on Ownership Card

The QR code printed on (the back of) the ownership card can be scanned to obtain a CVV (3-4 digits) that is temporarily stored in the scanning device. The QR code also obtains a URL that either brings the user to a digital wallet or starts a quick launch code. In addition to a QR code a quick launch code could be printed on the card. It is similar to a QR code but might be more trusted by users. In all cases the UI shows the user how to hold the plastic ownership card to the device to start the owner pairing process. This could be a native wallet UI or a UI provided by the vehicle manufacturer, which can be more specific about how the process works for this type of vehicle.

### QR Code/PIN on Separate Secret Document

If there is a need for stronger protection of the ownership card, the vehicle OEM can set a strong PIN code and send the value in a separate document that is sealed and needs to be opened by the real owner. If the seal is broken or the scratch surface already shows the PIN value, then users should not use the ownership card and return it to a dealer for example.

If the document shows a QR code, then scanning the code should bring the user into the same flow as scanning a QR code printed on the card. If the document does not show a QR code then it should provide instructions how to hold the card to the reader. Wallet should have a way to detect whether the PIN for this card is already known (from QR code) or needs to be entered manually and show a corresponding UI.

### NFC Detection and Verification of Ownership Card

Devices detect the ownership card that is held to the NFC antenna and launch a corresponding application, which can be wallet. If wallet has already received the CVV or PIN value then it can continue the flow described below. If not, wallet should show a PIN entry UI. Typical background tag reading notification when card is detected: Background tag reading is activated in mobile phones when the display is on. Users might know about it or they might learn through educational UI shown after a QR code or quick launch code scan, as described above.

The device uses NDEF to identify the tag and obtain the URL associated with the tag. NFCNDEFPayload contains a universal link or an URL scheme. A standardized universal URL is recommended as the card shall work with devices made by various manufacturers. The device OS shall know this URL and not open it in browsers. Instead, in some embodiments, it will automatically open it in wallet and start to the owner pairing flow, as if the user had tapped on it.

In addition to an NDEF section the tag also shall have the following functionality: Contain an ECC key pair; Contain a certificate for the public key that contains information about the associated vehicle, such as the VIN; Provides a signing function in which the card receives a hash payload and a nonce from the caller, adds its signature counter and usage value and signs the payload; Require a CVV or PIN to enable the signing command for the duration of an NFC session; Allows the caller to retrieve card nonce and signature and use the certificate to verify that the vehicle identity belongs to this ownership card; Velocity checking function to compare the signature counter value to the one when the card was used last time; Maximum counter limit for signatures of e.g. 100 attempts in the lifetime of the vehicle.

The root certificate that allows to verify the authenticity of the ownership card should be the same as already used for the car key PKI. In some embodiments, eligible devices already host it in their certificate store. Technically a separate root certificate could be provisioned in the devices, but that's not the preferred way

### Pairing

iAP data obtained during pairing can include car key eligibility information as defined in the MFi specification (TBD). Additionally the car should provide an URL under which the device can fetch the static eligibility information of the vehicle. TBC—Sven

### Easy Account Setup/Connection

If the user already has an account with the vehicle OEM, then a simple way would be to contact the OEM based on the name of the “me card” in the user's contacts and send a verification code to a credential on file (e.g. phone number verification). Some applications use a similar way to connect to an existing electrical provider company account. Otherwise, the generic flow is to require the OEM to offer a sign in feature to create a new OEM account or use the password app to log into an existing one that will be used to manage this vehicle. For users that don't want to use the sign in features other options can be offered as well, but vehicle OEMs are mandated to support this option.

### Flow Díagrams

### Option 1—Open Server Session During NFC Tap

One way to obtain a nonce trusted by the relying party (vehicle OEM server) is to fetch it during the NFC tap. If QR code is used prior to the NFC tap, the information contained in the QR code allows the device to pre-fetch the nonce from the vehicle server (VS). The NFC tap of the card will be very short and efficient in that situation. The VS can put a very tight usage window of e.g. 60 seconds on it until the user must have tapped the device for example. The user experience will likely be impacted by a very long holding time for the card of at least a few seconds, especially if internet connectivity is not good.

### Option 2—Offline NFC Tap

In this option the applet on the device SE generates the nonce. The VS relies on the fact that for each signature of the card the applet generates a new nonce and does not allow to re-use the same one again. Some flows leave the door open to re-use a random generated by the same applet on the same device again to gain access to the pairing password even without the possession of the card. This could be exploited by a former vehicle owner. To avoid this, the VS has to keep a deny list for all used randoms to avoid replay. Alternatively it can store the signature counter and not approve a signature that has the same or a lower counter value. Some flows offer the advantage of a very short tap as the device can be offline at this moment. Also the VS shall store the instance CA identifier provided in the certificate and make sure that the owner key tracking request provides the same instance CA. Otherwise the key tracking request shall be declined.

### Security

### Card Binding

The vehicle OEM creates the card by generating an ECC key pair and adding the VIN or another suitable identifier of the vehicle to the PK certificate. The certificate also contains a trusted URL that can be called by the device to obtain the pairing password. The PK is known to the vehicle server, in this proposition it does not need to be known to the vehicle itself.

### Card Verification

The possession of the card is verified by (optionally) knowing a CVV or a secret PIN that enables the sign command. The verifying entity sends a nonce and the card adds another nonce and a usage identifier (similar to other CCC sign operations) to verify that the private key matching the certificate with the VIN is held by the card. In addition, the certificate needs to be signed (maybe using an intermediate cert) by the root PK of the automaker, which is already embedded in our devices'trust store.

By sending the nonces and the signature to the URL obtained from the certificate the device obtains the pairing password for this vehicle. Note that the ownership card and also the obtained password is a strong factor in the ownership verification process. See open topics for how confidential the password has to be and whether other, weaker options such as email sending are still allowed.

### Account Binding

If an account is required by the automaker the user should be able to create one seamlessly through “a sign in feature. It shall be allowed to use the “Hide my email” option for anonymous account creation. The vehicle server is expected to pre-bind the vehicle to the account at this time. If stronger binding is required, then the vehicle server can provide an account token to the device that is sent to the vehicle during owner pairing. The vehicle then binds the account to its identity by adding it to the opaque attestation (or a new data element to be defined) that is signed by the vehicle and send back to the VS during key tracking. By validating the vehicle signature the VS can commit the binding between account and vehicle.

### Second Factor/Pairing Password

In this design the pairing password has become a strong factor to prove ownership to the vehicle and “replaces” the second key fob that is required by some vehicle OEMs today to start OP. In some embodiments, the user is required to bring an independent proof as second factor to the vehicle, which has to be a token/fob that enables at least to unlock the vehicle to be inside for owner pairing.

### Open Topics

Add various entry points to design. How to unbind the car from the previous owner's account? Auto-unmap on new use or explicit unmapping? Security: Has pairing password to be treated as a secret that represents a strong verification? Then, in some embodiments, it cannot be published in email or SMS anymore. Can SPAKE verifier be provisioned to the vehicle if vehicle is not yet bound to owner account? Use anonymous account and personalize later. OP start UI personalization per car OEM. Review to give the least control to the car OEM. When is the verifier provisioned in the vehicle? When is the car set to pairing mode? Add the following elements: Cleaning up/Fixing Owner Pairing UI Issues; Look to build on the customization of OP graphic identifier and build an infrastructure with certain images/educational text blocks that can be customized per OEM; Adding PPID to Owner Pairing URL & App API; Build an Owner Pairing URL deep link scheme that brings the user to the right portion of the OEM app; New tap to ownership card allows new person to do OP; Second factor to secure this? Set up a PIN managed by the device, so first tap card against old device, then against new device, also enter PIN on new device if communicated by old owner, PIN can be shown on old owner's pass.

### New Ideas

Trigger OP user interface when sitting in my car and device AI logic detects that I have purchased this vehicle; Manage ownership card on back of pass, e.g. notify OEM that it has been lost to disable it; Provide device handle (e.g. instance CA identifier) to VS when calling for pairing password or KIS sharing, to make sure that key goes to same device. Maybe even ownership card can sign this identifier (likely not yet provisioned at time of tapping, unless we go with QR code first and then tap), similar to pre-share call.

### Current Flows

Setting up digital services for an OEM, in some embodiments, requires a user to: Create an account with name and email; Email confirmation; Create password. The above 3 can be covered by a Sign in feature. App setup passcode or fingerprint. Manually enter VIN or scan VIN with camera. This info can be brought from owner pairing or setup card. Enter last name (again) to verify ownership. What if owner does not want to be registered? At least use the last name of the account? Link embrace car features to OEM account? Press info button in vehicle. Sends account number and temp PIN. Log into account. Enter SMS code. Note in video: how can you show “status unknown” for warranty. If previous owner has not removed their account, users must contact the local dealer, provide proof of ownership and ID. Connecting a car to an existing OEM account, in some embodiments, requires a user to: scan QR code on car UI. One step, successfully paired. Can add license plate number. Manage digital extras, activate all, one step. Scan or enter VIN (not shown). Go to dealer (not shown). Next is to enter a PIN on the vehicle UI. Then setup assistant. Enter home address. Connect BT phone. Voice recognition. No mention of digital key. Digital key handover. Have spare key in car, main key not there. Spare key will be deactivated in glove box. When someone needs to use the car, the spare key can be remotely activated.

Digital key setup: Go into the app, choose setup digital key; Bring one key fob; Pair via NFC; Owner key successfully configured; Security ok; When passive entry was switched off, then NFC worked without user auth.

### [Car Key] Streamlined Owner Pairing|One-Pager

### Strategic Alignment: User Experience Improvements, User Growth

### Business Impact/Success KPIs

Track anecdotal feedback from end-users and OEM partners on pain points of owner pairing. Work with OEMs to track adoption of car keys in Wallet over time. [number of provisioned car keys for a given brand] / [number of car key eligible vehicles sold for that brand] x % of users of an operating system.

### Scope

### Car Key Feature Discovery

NFC ownership card should be easily discoverable by the owner. Upon discovery, owners should be immediately aware of the following: ownership card is an element associated with vehicle ownership (i.e. on par with title/deed) that should be transferred in case of second hand sales to a new owner. The exact purpose of the ownership card (i.e. tap to phone in order to set up car key in Wallet). Ownership card should not be left inside the car, and is not easily replaceable. Alternative methods to initiating OP (e.g. vehicle headunit, OEM app, or email comm) should remain. However, the alternative methods should reference the ownership card as an easier way to setup car key in Wallet. An additional QR code printed on the card could trigger an instructions UI to explain how to tap the card. Pairing, if done first, should also trigger the education flow on how to tap the ownership card to the device.

### Wallet Education

User can optionally scan a QR code to learn about tapping the ownership card. Upon tapping ownership card on a mobile phone, owners should be able to proceed to setup flow in Wallet. Owner should be able to continue or set up at a later time. If the owner chooses to set up at a later time, there should be an indication in Wallet “+” flow that reminds users about completing the owner pairing.

### Owner Pairing

Pairing password should be seamlessly fetched by Wallet from the automaker server, without user involvement.

### Success Screen

Option to seamlessly enroll in automaker ecosystem for the usage of proprietary features. Link to download the app. Option to leverage existing owner key to authenticate in automaker account. Authentication through ownership card is virtually transferred to owner key and should be transferable to automaker account.

This feature's goal is to provide owners with the optimal method for obtaining their owner key on their device. This is one component of a broader effort to create an owner pairing experience. We propose an alternative to owner pairing under favorable circumstances, which is that the vehicle OEM's key issuance server (KIS) shares an owner key to the owner device, instead of going through owner pairing. This flow would be bootstrapped by the same ownership card, but is described in a different one-pager ([Car Key] Server-shared Owner Key|One-Pager). Internal: WTE, Wallet. External: NFC card manufacturers or issuers (should provide NFC tokens (e.g. plastic cards) as per CCC specification; Supporting automakers should be identified prior to starting development.

FIG. 600 is a flow diagram illustrating a process (e.g., process 600) for obtaining a pairing code in accordance with some embodiments. Some operations in process 600 are, optionally, combined, the orders of some operations are, optionally, changed, and some operations are, optionally, omitted.

As described below, process 600 provides an intuitive way for obtaining a pairing code in accordance with some embodiments. Process 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at a device (e.g., 300). In some embodiments, the device is a watch, a phone, a tablet, a fitness tracking device, a processor, a head-mounted display (HMD) device, a communal device, a media device, a speaker, a television, an electronic device, a camera, and/or a personal computing device. In some embodiments, one or more operations described below are performed by a system process (e.g., a process of an operating system) of the device. In some embodiments, one or more operations described below are performed by an application (e.g., a home application, a vehicle application, an accessory management application, and/or a wallet application) of the device.

The device receives (602), from a hardware component (e.g., NFC tag of 340, 322 and/or 330) (e.g., NFC chip and/or NFC tag), a credential (e.g., data at step 346, step 418 and/or step 502) (e.g., signature, certificate, electronic credential, and/or digital file) in conjunction with (e.g., in response to, while, or after) the device detecting (e.g., wirelessly detecting, such as via a wireless communication channel including NFC, UWB, Bluetooth, WiFi, or Thread) the hardware component. In some embodiments, the device detects the hardware component in response to the device being placed within a distance threshold of the hardware component. In some embodiments, the device detects the hardware component in response to the device providing power to the hardware component. In some embodiments, the hardware component is embedded within a physical component, such as a card or an accessory device.

In response to (or in conjunction with or after) receiving the credential, the device sends (604), to a server (e.g., 308) separate from the device, the credential (e.g., within a signature generated by the first device).

After (or in conjunction with) sending the credential (and/or as a response to sending the credential), the device receives (606), from the server, a pairing code (e.g., data at step 430 and/or step 360) (e.g., credential, key, password, PIN, and/or passphrase) corresponding to (e.g., directed to, related to, and/or associated with) another device e.g., 304), wherein the other device is separate from the device and the server. In some embodiments, the other device is a vehicle (e.g., automobile, boat, or plane), a watch, a phone, a tablet, a fitness tracking device, a processor, a head-mounted display (HMD) device, a communal device, a media device, a speaker, a television, an electronic device, a camera, and/or a personal computing device. In some embodiments, the other device is integrated and/or embedded in a vehicle (e.g., automobile, boat, or plane) and/or home. In some embodiments, the other device corresponds to (e.g., is associated with, is in communication with, relates to, and/or is manufactured by an entity that administers) the server.

After (or in conjunction with, such as in response to) receiving the pairing code, the device initiates (608), with the other device, a pairing process (e.g., as described with respect to FIGS. 3 and 4) (e.g., UWB pairing, Bluetooth pairing, cryptography pairing, and/or network pairing) using the pairing code. In some embodiments, the device receives entitlements with respect to the other device as a result of the device being paired with the other device. In some embodiments, the device initiates the pairing with the other device in response to receiving a signal from the other device. In some embodiments, the device receives an indication that the other device initiates the pairing process. In some embodiments, the pairing process includes use of the pairing code though the pairing process is initiated without the pairing code. In some embodiments, the pairing process is initiated using the pairing code.

In some embodiments, before receiving, from the hardware component, the credential, the device detects (e.g., wirelessly detecting, such as via a wireless communication channel including NFC, UWB, Bluetooth, WiFi, or Thread) the hardware component (e.g., as described with respect to FIGS. 3 and 4). In some embodiments, in conjunction with (e.g., in response to, while, or after) detecting the hardware component, the device sends, to the hardware component, an identifier (e.g., a credential, an authentication credential, a serial number, a model number, an IP address, and/or MAC address) of the device. In some embodiments, the device detects the hardware component in response to the hardware component transitioning from being greater than a threshold distance to being less than the threshold distance from the device. In some embodiments, the device detects the hardware component in response to the hardware component being powered on by the device and sending a communication to the device. In some embodiments, the device ceases detection of the hardware component in response to the hardware component transitioning from being less than the threshold distance to being greater than the threshold distance from the device. In some embodiments, the device ceases detection of the hardware component in response to the hardware component no longer being powered by the device and/or the device not receiving a communication from the hardware component for more than a predefined period of time (e.g., 2 seconds to 30 seconds).

In some embodiments, the identifier of the device is digitally bound to (e.g., added to, included with, used to sign, used to generate, tied to, combined with, merged with, united to, fused with, and/or integrated into) the credential when (e.g., after, in response to, and/or in conjunction with) the device receives the credential (e.g., as described ab above FIGS. 3 and 4). In some embodiments, the hardware component binds the identifier of the device to the credential. In some embodiments, another device other than the hardware component and the device binds the identifier of the device to the credential.

In some embodiments, in conjunction with (e.g., before, after, concurrently with, and/or as part of) sending, to the server, the credential, the device sends, to the server, an identifier (e.g., as described above with respect to FIGS. 3 and 4) (e.g., a credential, an authentication credential, a serial number, a model number, an IP address, and/or MAC address) of the device. In some embodiments, the device packages the identifier of the device with the credential. In some embodiments, the device separately sends the identifier of the device and the credential in a serial fashion. In some embodiments, the device digitally binds the identifier of the device and the credential prior to the device sending the identifier of the device to the server.

In some embodiments, the device sends, to the server, the credential and the identifier of the device via (e.g., within, as part of, integrated within, embedded within) a signature (and/or a security binary large object (blob)) (e.g., as described above with respect to FIG and 4). In some embodiments, the signature is generated using the credential and the identifier of the device.

In some embodiments, the identifier of the device is bound to (e.g. added to, included with, used to sign, used to generate, tied, combined, merged, united, fused, and/or integrated) the pairing code when (e.g., after, in response to, and/or in conjunction with) the device receives, from the server, the pairing code (e.g., as described above with respect to FIG. 4). In some embodiments, the server binds the second identifier of the device to the pairing code. In some embodiments, a device different from the server binds the second identifier of the device to the pairing code. In some embodiments, the second identifier of the device is not bound to the pairing code when the device receives, from the server, the pairing code.

In some embodiments, the identifier of the device is a first identifier of the device. In some embodiments, in conjunction with (e.g., in response to, as part of, while, and/or after) initiating, with the other device, (and/or as part of) the pairing process, the device sends, to the other device, a second identifier (e.g., a credential, an authentication credential, a serial number, a model number, an IP address, and/or MAC address) of the device (e.g., as described above with respect to FIG. 4.). In some embodiments, the device sends the second identifier to the other device before or after the pairing process. In some embodiments, the second identifier is the first identifier. In some embodiments, the second identifier is different from the first identifier.

In some embodiments, the device, as part of the pairing process (and/or as part of initiating the pairing process), sends, to the other device, the credential (e.g., as described above with respect to FIG. 4). In some embodiments, the device binds an identifier of the device to the credential prior to sending, to the other device, the credential. In some embodiments, the device sends the credential to the other device before or after the pairing process.

In some embodiments, after (e.g., in conjunction with and/or in response to) receiving the pairing code, the device sends, to the other device, an identifier (e.g., a credential, an authentication credential, a serial number, a model number, an IP address, and/or MAC address) of the device (e.g., as described above with respect to FIG. 4). In some embodiments, the device sends, to the other device, the identifier of the device before initiating the pairing process. In some embodiments, the device sends, to the other device, the identifier of the device while initiating the pairing process. In some embodiments, the device cannot initiate the pairing process until the device sends, to the other device, the identifier of the device.

In some embodiments, the hardware component is a near field communication (NFC) tag (or chip) (e.g., as described above with respect to FIGS. 3, 4, and 5). In some embodiments, the NFC tag is embedded within a physical device such as a card or an accessory device. In some embodiments, the NFC tag attached to the physical device.

In some embodiments, the device is in communication (e.g., wired communication and/or wireless communication) with (and/or includes) one or more display generation components (e.g., a display screen, a projector, a head mounted display, and/or a touch-sensitive display). In some embodiments, before (or while or in conjunction with) receiving, from the hardware component, the credential, the device detects the hardware component. In some embodiments, the device detects the hardware component in response to the device being placed within a distance threshold of the hardware component. In some embodiments, the device detects the hardware component in response to the device providing power to the hardware component and/or the device receiving a communication from the hardware component. In some embodiments, in response to detecting the hardware component (and/or in conjunction with, such as before, while, after, or in response to, receiving the credential), the device displays, via the one or more display generation components, a user interface including content related to pairing of the device to the other device (e.g., as described above with respect to FIGS. 3 and 4). In some embodiments, the device ceases display of the user interface when the device ceases detection of the hardware component. In some embodiments, the device displays (or maintains displays of) the user interface while the device receives the credential. In some embodiments, the device displays (and/or maintains display of) the user interface before and/or after the device receives the credential. In some embodiments, the content includes information with respect to how to receive the credential from the hardware component (e.g., bring the device nearby the hardware component).

In some embodiments, the other device is a vehicle (e.g., as described above with respect to FIGS. 3, 4, and 5) (e.g., an automobile, a plane, an airplane, and/or a boat).

In some embodiments, the other device is an accessory (e.g., as described above with respect to FIG. 3) (e.g., a device configured to be controlled by one or more other devices, such as the device).

In some embodiments, the device is in communication (e.g., wired communication and/or wireless communication) with (and/or includes) one or more cameras (e.g., a periscope camera, a telephoto camera, a wide-angle camera, and/or an ultra-wide-angle camera) and one or more display generation components (e.g., a display screen, a projector, a head mounted display, and/or a touch-sensitive display). In some embodiments, before (or while, after, or in conjunction with) receiving the credential, the device detects, via the one or more cameras, a quick response code that corresponds to (e.g., directed to, at a location of, related to, and/or associated with) the hardware component. In some embodiments, the hardware component and the quick response code are attached and/or embedded within a common physical component such as a card or an accessory device. In some embodiments, in response to detecting the quick response code, the device displays, via the one or more display generation components, a user interface with instructions on how to interact with the hardware component (e.g., how to activate the hardware component, how to receive data from the hardware component, and/or how to power on the hardware component) (e.g., as described above with respect to FIGS. 3 and 4). In some embodiments, the user interface includes instructions on how to pair the device with the other device.

In some embodiments, after initiating, with the other device, the pairing process and in accordance with a determination that the device is paired with the other device, the device receives, from the other device, a confirmation that the device is paired with the other device (e.g., as described above with respect to FIG. 4). In some embodiments, after initiating the pairing process and in accordance with a determination that device is not paired with the other device, the device does not receive the confirmation from the other device. In some embodiments, in response to receiving the confirmation that the device is paired with the other device, the device outputs (e.g., visually outputs and/or audibly outputs) an indication that the device is paired with the other device.

In some embodiments, after initiating, with the other device, the pairing process, the device pairs with the other device (e.g., pairing using the pairing code and/or the pairing process). In some embodiments, after pairing with the device (e.g., in conjunction with pairing with the other device and/or in response to pairing with the other device), the device sends, to the server, a confirmation (e.g., as described above with respect to FIG. 4) that the device is paired with the other device. In some embodiments, after initiating the pairing process and in accordance with a determination that the pairing process is unsuccessful, the device does not send to the server the confirmation that the device is paired with the other device.

In some embodiments, before sending, to the server, the confirmation that the device is paired with the other device and after pairing with the other device, the device receives, from the other device, the confirmation that the device is paired with the other device (e.g., as described above with respect to FIG. 4). In some embodiments, the device receives, from the other device, the confirmation that the device is paired with the other device in accordance with a determination that the device and the other device are paired. In some embodiments, after initiating the pairing process and in accordance with a determination that device is not paired with the other device, the device does not receive, from the other device, the confirmation that the device is paired with the other device. In some embodiments, in response to receiving the confirmation that the device is paired with the other device, the device outputs (e.g., visually outputs and/or audibly outputs) an indication (e.g., a visually indication and/or an audible indication) that the device is paired with the other device.

In some embodiments, after (or while) sending, to the server, the confirmation that the device is paired with the other device, the device receives, from the server, a signature (e.g., as described above with respect to FIG. 4). In some embodiments, in conjunction with (e.g., in response to, while, or after) receiving the signature, the device sends, to the other device, the signature. In some embodiments, the device does not send the signature to the device. In some embodiments, the device sends, to the other device, the signature in response to receiving a request from the other device.

In some embodiments, after initiating, with the other device, the pairing process, the device pairs with the other device (e.g., pairing using the pairing code and/or the pairing process). In some embodiments, in conjunction with (e.g., after, in response to, based on) pairing with the other device, the device receives, from the server, a digital credential (e.g., a key, password, PIN, and/or passphrase) for accessing the other device (e.g., as described above with respect to FIGS. 3 and 4) (e.g., unlocking, locking, accessing one or more accessories, powering on and/or powering off). In some embodiments, the digital credential grants the device one or more entitlements with respect to the other device. In some embodiments, after initiating the pairing process and in accordance with a determination that the pairing process is unsuccessful, the device does not receive the digital credential for accessing the other device.

In some embodiments, the pairing code is included in (e.g., or is and/or associated with) a uniform resource locator (URL) (e.g., as described above with respect to FIG. 4). In some embodiments, the pairing code is accessed via the URL. In some embodiments, the URL adds the pairing code to the device.

In some embodiments, the device is in communication (e.g., wired communication and/or wireless communication) with (and/or includes) one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, in response to (e.g., after or in conjunction with) receiving, from the server, the pairing code, the device displays, via the one or more display generation components, a representation (e.g., a textual representation and/or a graphical representation) of the URL (e.g., as described above with respect to FIG. 4). In some embodiments, while displaying the representation of the URL, the device detects, via the one or more input devices, an input (e.g., a tap input, a voice command, voice command and/or a depression of a hardware component) directed to the representation of the URL. In some embodiments, in response to detecting the input directed to the representation of the URL, the device adds, to an application (e.g., a certificate application, a wallet application, a home application, a messaging application, a maps application, a fitness application, a health application, a digital payments application, a media application, and/or a social network application) of the device, a digital certificate (e.g., on the device or another device different from the device) corresponding to the pairing code (e.g., as described above with respect to FIG. 4). In some embodiments, in conjunction with (e.g., in response or after) detecting the input directed to the representation of the URL, the device receives (e.g., downloads), from a pass file targeted by or included with the URL, the digital certificate. In some embodiments, as part of receiving the digital certificate, the device, downloads, parses (e.g., interprets), and/or displays information related to the digital certificate. In some embodiments, the pass file is stored on a server that is remote to the device.

In some embodiments, the server corresponds to (e.g., directed to, related to, and/or associated with) a manufacturer of the other device (e.g., as described above with respect to FIG. 3). In some embodiments, the server does not correspond to the manufacturer of the other device. In some embodiments, the manufacturer manufactures both the other device and the server. In some embodiments, the manufacturer manufactures the device and owns the server.

In some embodiments, the credential includes an identification (e.g., VIN, serial number, model number) of the other device (e.g., as described above with respect to FIGS. 3 and 4).

Note that details of the processes described above with respect to process 600 (e.g., FIG. 6) are also applicable in an analogous manner to other processes described herein. For example, process 700 optionally includes one or more of the characteristics of the various processes described above with reference to process 600. For example, the hardware component of process 700 can be the hardware component of process 600. For brevity, these details are not repeated herein.

FIG. 7 is a flow diagram illustrating a process (e.g., process 700) for establishing different types of ownership in accordance with some embodiments. Some operations in process 700 are, optionally, combined, the orders of some operations are, optionally, changed, and some operations are, optionally, omitted.

As described below, process 700 provides an intuitive way for establishing different types of ownership in accordance with some embodiments. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a first device (e.g., 300). In some embodiments, the first device is a watch, a phone, a tablet, a fitness tracking device, a processor, a head-mounted display (HMD) device, a communal device, a media device, a speaker, a television, an electronic device, a camera, and/or a personal computing device. In some embodiments, one or more operations described below are performed by a system process (e.g., a process of an operating system) of the first device. In some embodiments, one or more operations described below are performed by an application (e.g., a home application, a vehicle application, an accessory management application, and/or a wallet application) of the first device.

After (or in conjunction with, such as in response to) obtaining, from a hardware component (e.g., NFC tag of 340, 322, or 330) (e.g., NFC chip and/or NFC tag), a credential (e.g., data at step 346, data at step 418 and/or data at step 502)) (e.g., signature, electronic credential, and/or digital file), the first device sends (702), to a server (e.g., 308) separate from the first device, the credential (e.g., within a signature generated by the first device). In some embodiments, the hardware component is embedded within a physical component, such as a card or an accessory device. In some embodiments, the first device sends an identifier of the first device to the server as part of sending the credential to the server. In some embodiments, the first device sends the identifier of the first device to the hardware component before obtaining the credential from the hardware component.

After (704) (or in conjunction with, such as a result of) sending the credential to the server, in accordance with a determination that the server has not shared an owner key for a second device (e.g., 304) (and/or that an ownership of the second device is not currently established, such as with the server, such as a device is currently not established as an owner of the second device), the first device receives (706), from the server, data (e.g., an address, a URL, and/or URI) without a pairing code (e.g., data received at step 508). In some embodiments, the first device did not previously establish the ownership of the second device. In some embodiments, the first device is not in communication with the second device when the data without a pairing code is received. In some embodiments, the second device is a watch, a phone, a tablet, a fitness tracking device, a processor, a head-mounted display (HMD) device, a communal device, a media device, a speaker, a television, an electronic device, a camera, and/or a personal computing device. In some embodiments, the second device is integrated and/or embedded in a vehicle (e.g., automobile, boat, or plane) and/or physical structure. In some embodiments, in response to receiving the data without a pairing code, the first device displays a representation of the data without a pairing code. In some embodiments, the data without a pairing code is a digital credential for accessing the second device. In some embodiments, the second device corresponds to (e.g., is associated with, is in communication with, relates to, and/or is manufactured by an entity that administers) the server.

After (704) sending the credential to the server, in accordance with a determination that the server has shared an owner key for the second device (and/or that an ownership of the second device is currently established, such as with the server, such as a device is currently established as an owner of the second device), the first device receives (708), from the server, data with (and/or including) a first pairing code (e.g., data received at step 430) (e.g., a series of alphanumeric symbols for pairing the first device with the second device). In some embodiments, the first device displays a representation of the data with the first pairing code in response to receiving the data with first the pairing code. In some embodiments, the data with the first pairing code is a pairing code. In some embodiments, the data with the first pairing code is a digital credential for accessing the second device.

In some embodiments, the data without a pairing code is (e.g. includes) a uniform resource locator (e.g., as described above with respect to FIG. 5) (URL) (and/or an address and/or a uniform resource identifier (URI)). In some embodiments, the first device displays a representation of the URL. In some embodiments, the first device receives a digital credential in conjunction with the first device detecting an input directed to selection of the representation of the URL. In some embodiments, the data with the first pairing code is a URL. In some embodiments, the data with the first pairing code is not a URL.

In some embodiments, the server is a first server. In some embodiments, the first device is in communication (e.g., wired communication and/or wireless communication) with (and/or includes) one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, in response to receiving, from the first server, the data without a pairing code, the first device displays, via the one or more display generation components, a representation (e.g., a textual representation and/or a graphical representation) of the data without a pairing code (e.g. as described above with respect to FIG. 5). In some embodiments, the representation of the data without a pairing code is a virtual button, an icon, a widget, a control, and/or a window. In some embodiments, while displaying the representation of the data without a pairing code, the first device detects, via the one or more input devices, an input (e.g., a tap input, a voice command, a gaze input, and/or a depression of a physical hardware component) directed to (e.g., at a location of, associated with, and/or corresponding to) the representation of the data without a pairing code. In some embodiments, in conjunction with (e.g., after, while, or in response to) detecting the input directed to the representation of the data without a pairing code, the first device receives, from a second server (e.g., 570), a digital credential (e.g., data included at step 510) (e.g., a key, password, PIN, and/or passphrase). In some embodiments, the first device receives one or more entitlements with respect to the second device as a part of receiving the digital credential (e.g., as descried above with respect to FIG. 5). In some embodiments, the first device stores the digital credential on the first device or on a device other than the first device. In some embodiments, the digital credential corresponds to the second device.

In some embodiments, the second server is different from the first server (e.g. as described above with respect to FIG. 5). In some embodiments, the second server is the first server. In some embodiments, the second server is in communication with the first server.

In some embodiments, the data without a pairing code is transmitted from the second server to the first server before (or while, after, or in conjunction with) the first device receives, from the first server, the data without a pairing code (e.g., as escribed above with respect to FIG. 5). In some embodiments, the first device receives the data without a pairing code from the second server. In some embodiments, the second server generates the data without a pairing code. In some embodiments, the second server receives the data without a pairing code from a device different from the first device.

In some embodiments, the server is a first server. In some embodiments, after (e.g., in conjunction with, in response to, or while) receiving, from the first server, the data with the first pairing code, the first device pairs (e.g., UWB pairing, Bluetooth pairing, cryptography pairing, and/or network pairing), using the data with the first pairing code, the first device with the second device (e.g., as described above at step 432). In some embodiments, in conjunction with (e.g., after, while, and/or in response to) pairing the first device with the second device, the first device receives, from a third server (e.g., 308 or 570), a digital credential (e.g., a key, password, PIN, and/or passphrase). In some embodiments, the third server is the first server or the second server. In some embodiments, the third server is different from the first server and the second server. In some embodiments, the digital credential is received from the second device. In some embodiments, the first device receives one or more entitlements with respect to the second device as a part of receiving the digital credential. In some embodiments, the first device stores the digital credential on the first device or on a device other than the first device. In some embodiments, the digital credential corresponds to the second device.

In some embodiments, the determination that the server has shared an owner key for the second device includes a determination that an owner digital credential (e.g., a key, password, PIN, and/or passphrase) is already registered (e.g., on behalf of the second device) with (e.g., associated with, bounded with, and/or assigned to) the second device (e.g. as described above with respect to FIG. 5). In some embodiments, the server is a first server. In some embodiments, the determination that the second device is currently registered with the second device includes a determination that the digital credential is stored on (e.g., exists, saved on, or accessible by) a fourth server (e.g., 308 and/or 570). In some embodiments, the fourth server is different from the first server. In some embodiments, the fourth server is the first server. In some embodiments, the fourth server is in communication with the first device and/or the first server. In some embodiments, the digital credential is maintained on the fourth server when a new credential for the first device is created.

In some embodiments, the determination that the server has not shared an owner key for the second device includes a determination that an owner digital credential (e.g., a key, password, PIN, and/or passphrase) (e.g., any digital credential) is not registered (e.g., associated with, bounded with, and/or assigned to) with the second device (e.g. as described above with respect to FIG. 4). In some embodiments, a digital credential that was previously registered with the second device previously existed on a respective server but no longer exists on the respective server (e.g., the digital credential was removed and/or deleted) when the first device receives the data. In some embodiments, there is a digital credential registered with the second device when the first device receives, from the first server, the data with the first pairing code.

In some embodiments, before sending, to the first server, the credential and in conjunction with (e.g., while, based on, in response to, and/or after) the first device being within proximity (e.g., close enough to power and/or a predetermined distance, such as 0.5-24 inches) of the hardware component, the first device obtains, from the hardware component, the credential (e.g., as described above with respect to FIGS. 3, 4 and 5). In some embodiments, the first device obtains, from the hardware component, the credential in accordance with a determination that the first device is within the predetermined distance of the hardware component. In some embodiments, the first device provides power the hardware component in response to the first device being within the predetermined distance of the hardware component.

In some embodiments, after (e.g., in response to or in conjunction with) receiving, from the first server, the data with the first pairing code, the first device pairs (e.g., UWB pairing, Bluetooth pairing, cryptography pairing, and/or network pairing), using the data with the first pairing code (and/or using the pairing code), the first device to the second device (e.g., as described above with respect to FIG. 4). In some embodiments, the first device initiates a pairing process with the second device. In some embodiments, the first device receives, from the second device, a request to perform the pairing process. In some embodiments, after receiving, from the first server, the data without a pairing code, the first device forgoes pair of the first device to the second device. In some embodiments, the first device cannot pair to the second device when the first device receives the data without a pairing code. In some embodiments, a device other than the first device is paired with the second device when the first device cannot pair with the second device. In some embodiments, after receiving, from the first server, the data without a pairing code, the first device temporarily pairs and/or temporarily gains access to control the second device. In some embodiments, after receiving, from the first server, the data without a pairing code, the first device pairs (e.g., without using the pairing code and/or any pairing code) to the second device.

In some embodiments, after receiving, from the first server, the data without a pairing code, the first device obtains (e.g., from the first server, from a server different from the first server, from the second device, and/or from a device different from the first device) a set of one or more entitlements (e.g., ability to control one or more functions of the second device, power on and/or off the second device, and/or controlling one or more computers of the second device) with respect to (e.g., corresponding to, directed to, related to, and/or associated with) the second device (e.g., as described above with respect to FIG. 5). In some embodiments, after receiving, from the first server, the data without a pairing code, the set of one or more entitlements are obtained using the data without a pairing code (e.g., to register the first device with the second device). In some embodiments, after receiving, from the first server, the data with the first pairing code, the first device obtains (e.g., from the first server, from a server different from the first sever, from the second device, and/or from a device different from the first device) the set of one or more entitlements with respect to the second device in conjunction with (e.g., in response to, after, because) the data with the first pairing code being used to register the first device with the second device. In some embodiments, after receiving, from the first server, the data with the first pairing code, the set of one or more entitlements are obtained using the data with the first pairing code (and/or using the pairing code) (e.g., to register the first device with the second device). In some embodiments, after receiving, from the first server, the data with the first pairing code, the first device obtains (e.g., from the first server, from a server different from the first sever, from the second device, and/or from a device different from the first device) another set of one or more entitlements with respect to the second device. In some embodiments, the other set of one or more entitlements is different from the set of one or more entitlements. In some embodiments, the other set of one or more entitlements are obtained as a result of registered with the second device using the data with the first pairing code instead of using the data without a pairing code. In some embodiments, the other set one or more entitlements includes a greater number of entitlements (and/or a greater extent of entitlements) than the set of one or more entitlements. In some embodiments, the first device obtains a greater number of entitlements (and/or a greater extent of entitlements) when the data with the first pairing code is used to register the first device with the second device than when the data without a pairing code is used to register the first device with the second device.

Note that details of the processes described above with respect to process 700 (e.g., FIG. 7) are also applicable in an analogous manner to the processes described herein. For example, process 600 optionally includes one or more of the characteristics of the various processes described herein with reference to process 700. For example, the credential of process 600 can be the credential of process 700. For brevity, these details are not repeated herein.

In some embodiments, a first computer system (as described herein) performs processes 600 and/or 700 (FIGS. 6 and/or 7) via a system process (e.g., an operating system process and/or a server system process) that is different from one or more applications executing and/or installed on the first computer system.

In some embodiments, a first computer system (as described herein) performs processes 600 and/or 700 (FIGS. 6 and/or 7) via an application that is different from a system process.

In some embodiments, the instructions of the application, when executed, control the first computer system to perform processes 600 and/or 700 (FIGS. 6 and/or 7) by calling an application programming interface (API) provided by the system process. In some embodiments, the application performs at least a portion of processes 600 and/or 700 (FIGS. 6 and/or 7) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 600 and/or 700 (FIGS. 6 and/or 17) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 600 and/or 700 (FIGS. 6 and/or 7) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 600 and/or 700 (FIGS. 6 and/or 7).

In some embodiments, API 176 defines a first API call response that can be provided to an application by API calling instructions 174, wherein the first API call response includes parameters described above with respect to processes 600 and/or 700 (FIGS. 6 and/or 7).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a device pairs with another device. The present disclosure contemplates that in some instances, this gathered data can include personal information data that uniquely identifies or can be used to contact or locate a specific person. Such personal information data can include demographic data, vehicle data, location-based data, telephone numbers, email addresses, home addresses, or any other identifying information.

The present disclosure recognizes that the use of such personal information data, in the present technology, can be used to the benefit of users. For example, the personal information data can be used to determine which devices should be paired. Accordingly, use of such personal information data enables an improved pairing process. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, devices can be paired by inferring location based on non-personal information data or a bare minimum amount of personal information.

What is claimed is:

1. A method, comprising:
at a device:
receiving, from a hardware component, a credential in conjunction with the device detecting the hardware component;
in response to receiving the credential, sending, to a server separate from the device, the credential;
after sending the credential, receiving, from the server, a pairing code corresponding to another device, wherein the other device is separate from the device and the server; and
after receiving the pairing code, initiating, with the other device, a pairing process using the pairing code.

2. The method of claim 1, further comprising:
before receiving, from the hardware component, the credential, detecting the hardware component; and
in conjunction with detecting the hardware component, sending, to the hardware component, an identifier of the device.

3. The method of claim 2, wherein the identifier of the device is digitally binded to the credential when the device receives the credential.

4. The method of claim 1, further comprising:
in conjunction with sending, to the server, the credential, sending, to the server, an identifier of the device.

5. The method of claim 4, wherein the device sends, to the server, the credential and the identifier of the device via a signature.

6. The method of claim 4, wherein the identifier of the device is binded to the pairing code when the device receives, from the server, the pairing code.

7. The method of claim 4, wherein the identifier of the device is a first identifier of the device, the method further comprising:
in conjunction with initiating, with the other device, the pairing process, sending, to the other device, a second identifier of the device.

8. The method of claim 1, further comprising:
as part of the pairing process, sending, to the other device, the credential.

9. The method of claim 1, further comprising:
after receiving the pairing code, sending, to the other device, an identifier of the device.

10. The method of claim 1, wherein the hardware component is a near field communication (NFC) tag.

11. The method of claim 1, wherein the device is in communication with one or more display generation components, the method further comprising:
before receiving, from the hardware component, the credential, detecting the hardware component; and
in response to detecting the hardware component, displaying, via the one or more display generation components, a user interface including content related to pairing of the device to the other device.

12. The method of claim 1, wherein the other device is a vehicle.

13. The method of claim 1, wherein the other device is an accessory.

14. The method of claim 1, wherein the device is in communication with one or more cameras and one or more display generation components, the method further comprising:
before receiving the credential, detecting, via the one or more cameras, a quick response code that corresponds to the hardware component; and
in response to detecting the quick response code, displaying, via the one or more display generation components, a user interface with instructions on how to interact with the hardware component.

15. The method of claim 1, further comprising:
after initiating, with the other device, the pairing process and in accordance with a determination that the device is paired with the other device, receiving, from the other device, a confirmation that the device is paired with the other device.

16. The method of claim 1, further comprising:
after initiating, with the other device, the pairing process, pairing with the other device; and
after pairing with the device, sending, to the server, a confirmation that the device is paired with the other device.

17. The method of claim 16, further comprising:
before sending, to the server, the confirmation that the device is paired with the other device and after pairing with the other device, receiving, from the other device, the confirmation that the device is paired with the other device.

18. The method of claim 16, further comprising:
after sending, to the server, the confirmation that the device is paired with the other device, receiving, from the server, a signature; and
in conjunction with receiving the signature, sending, to the other device, the signature.

19. The method of claim 1, further comprising:
after initiating, with the other device, the pairing process, pairing with the other device; and
in conjunction with pairing with the other device, receiving, from the server, a digital credential for accessing the other device.

20. The method of claim 1, wherein the pairing code is included in a uniform resource locator (URL).

21. The method of claim 20, wherein the device is in communication with one or more display generation components and one or more input devices, the method further comprising:
in response to receiving, from the server, the pairing code, displaying, via the one or more display generation components, a representation of the URL;
while displaying the representation of the URL, detecting, via the one or more input devices, an input directed to the representation of the URL; and
in response to detecting the input directed to the representation of the URL, adding, to an application of the device, a digital certificate corresponding to the pairing code.

22. The method of claim 1, wherein the server corresponds to a manufacturer of the other device.

23. The method of claim 1, wherein the credential includes an identification of the other device.

24. A non-transitory computer-readable storage medium storing one or more programs configured to be executed by one or more processors of a device, the one or more programs including instructions for:
receiving, from a hardware component, a credential in conjunction with the device detecting the hardware component;
in response to receiving the credential, sending, to a server separate from the device, the credential;
after sending the credential, receiving, from the server, a pairing code corresponding to another device, wherein the other device is separate from the device and the server; and
after receiving the pairing code, initiating, with the other device, a pairing process using the pairing code.

25. A device, comprising:
one or more processors; and
memory storing one or more programs configured to be executed by the one or more processors, the one or more programs including instructions for:
receiving, from a hardware component, a credential in conjunction with the device detecting the hardware component;
in response to receiving the credential, sending, to a server separate from the device, the credential;
after sending the credential, receiving, from the server, a pairing code corresponding to another device, wherein the other device is separate from the device and the server; and
after receiving the pairing code, initiating, with the other device, a pairing process using the pairing code.
